(19) United States
(12) Patent Application Publication
(10) Pub. No.: US 2013/0275504 A1
(43) Pub. Date: Oct. 17, 2013

(54) COMMUNITY OF INTEREST NETWORKS

(71) Applicants: Pulin Patel, McKinney, TX (US); Achal Patel, McKinney, TX (US); Alin Jayant, Victoria (CA)

(72) Inventors: Pulin Patel, McKinney, TX (US); Achal Patel, McKinney, TX (US); Alin Jayant, Victoria (CA)

(21) Appl. No.: 13/444,661

(22) Filed: Apr. 11, 2012

(51) Int. Cl. G06F 15/16

(52) U.S. Cl. 709/204

(57) ABSTRACT

Systems, methods, and computer program products for providing a community of interest network (CoIN) may include a publisher configured to provide content to a user across a network, the publisher configured to identify a CoIN parameter based on user network activity. A communications services provider may be configured to provide communications services to the user across the network based on the identified community of interest network.

### TECHNICAL FIELD

The present disclosure relates to the field of telecommunications, and more particularly, to the field of video, voice, and data communication for the creation and deployment of a community of interest network and the services provided to its users.

### BACKGROUND

Telecommunications networks that include network elements such as Mobile Switching Centers (MSC), Base Station Controllers (BSC) and Base Transceiver Stations (BTS)/Radio covering a particular geographic area, are implemented by network operators to provide services such as voice, data, video, messaging, mobility and several other communication services. In a communications network, an individual can place a targeted call to another user of the network. The elements used to complete the call include a switch (MSC) and a directory (home location register (HLR)/visiting location register (VLR)). To place a call the calling party needs to be aware of the called party number. Both the calling party and the called party numbers are pre-provisioned in the directory. The switch, which is a network element, is responsible for setting up the call between the two end-points, allocating resources for the call, and tearing down the call. The switch is also responsible for supplementary services such as call hold when the called party is busy. In networks such as these, call initiation is the responsibility of an end point in the network, and the network expects the calling party to be aware of the called party's number.

IP networks, which are different from conventional fixed-line and mobile networks, are built to provide connectivity and routing between IP endpoints. Such networks are also not aware of the service interest of the IP endpoint at any intermediate point in the network. For example, the IP-based communication network can provide voice/video/messaging communication between two user endpoints when a service request is initiated from either the server or a client. Web sites which act as servers in the IP network, but have the potential to act as intermediate points between several client interactions, do not play the role of service anchors between these clients today.

### SUMMARY

The present disclosure describes systems, methods, and apparatuses for providing a community of interest network (CoIN). A publisher may be configured to provide content to a user across a network. The publisher can be configured to identify a CoIN parameter based on user network activity. A communications services provider may be configured to provide communications services to the user across the network based on the identified community of interest network. In certain implementations, the user network activity may be the user visiting a web page offered by the content provider.

In certain implementations, the content provider may be configured to register a community of interest with the communications services provider, the community of interest used by the communications services provider to identify the services associated with a community of interest network. The communication service provider may provide communications services to the user upon identification of a community of interest network based on a parameter provided by the content provider.

In certain implementations, the publisher is configured to identify a COIN parameter based on user network activity with no interruption to the publishing of content.

In certain implementations, the community of interest parameters may include one or more of network activity, search keywords, tagwords, algorithms, webpage portion, website or webpage domains, uniform resource locators, uniform resource identifiers, cookie information, Internet browsing history information, device type, CoIN lifetime or operational times, communication services for a particular CoIN or authorized enhancements thereto. The registration information may include one or more of default settings; billing information; user information; location information; content type; marketing information; bandwidth limitations; contact information; coding; or other resources for automated communication systems. The instructions may also include receiving application programming interface (API) keys associated with a publisher.

Certain aspects of the disclosure are directed to systems, methods, and apparatuses executing instructions on a hardware processor that include identifying one or more communications services associated with a community of interest network (CoIN). A request for video conferencing services may be identified. Whether video conference services are within a set authorized communications services can also be identified or determined. A notification may be provided to users of the CoIN that video conferencing is available. An interface for video conferencing may be provided to at least a portion of the users of the CoIN.

Certain aspects of the disclosure are directed to systems, methods, and apparatuses executing instructions on a hardware processor that include validating a request to establish a network service. Billing and service parameters can be exchanged. A dynamic community of interest can be associated with the network service. In certain implementations, the instructions may also include providing the network service requested by members of CoIN.

Certain aspects of the disclosure are directed to systems, methods, and apparatuses executing instructions on a hardware processor that include activating the extension of one or more network services of a first type associated with a community of interest network to network domains of a second type. The network domain of the second type may include one or more of Play Station Network, xBox Live Network, Mobile Cellular Network, Public Telephony Network, Email network, SMS network, or Instant Messaging Network.

Certain aspects of the disclosure are directed to a computer implemented method for providing a community of interest network. The method may include receiving an indication of network activity of a user. A community of interest network may be identified based on the indication for online content. A processor may be instructed to provide the user with communication services associated with the community of interest network. In certain implementations, instructing a processor to provide the user with communication services associated with the community of interest network includes instructing a communications service provider to provide the user with communication services across a network. Certain implementations may include providing a list of parameters to a communications service provider, the list of parameters identifying at least a community of interest associated with a community of interest network. Certain implementations may include identifying a communications service associated with the community of interest network. In certain implementations, an indication that the user is visiting a web page associated with an online content provider is received.

In certain instances, the user is making an online query. In certain instances, the network activity may include connecting to a Wi-Fi hotspot. In certain implementations, receiving the indication of network activity may include receiving an indication across a network of the user's location. In certain implementations, the network activity consists of viewing a TV channel.

Certain aspects of the disclosure are directed to a computer implemented method for providing community of interest network services. An indication that a user is requesting access to a community of interest network may be received. A community of interest network for the user may be identified based on a community of interest. Communications services may be provided to the user across a network, the communication services may be configured to provide the user access to the community of interest network. Certain implementations may include receiving a registration from a content provider, the registration providing an indication of a community of interest.

Certain aspects of the disclosure are directed to a computer implemented method for establishing a community of interest network (CoIN). An indication may be received from a user for access to content. Real-time network service may be requested across an Internet protocol (IP) network from a service provider. Real-time communications interface may be received across the IP network from the service provider. The real-time communications interface may be provided to the user, the real-time communications interface associated with a community of interest associated with the content, the real-time communications interface facilitating live interactive communication between members of the community of interest network.

Aspects of certain implementations include adding the user to the community of interest network based on the indication from the user for access to the content. A second user may be added to the community of interest network based on the indication from the second user for access to the second content. In certain implementations, the indication from the user is a keyword search. One or more community of interest networks may be identified based on the keyword search. A listing of the one or more community of interest networks may be provided to the user. An indication may be received from the user of one or more preferred community of interest networks. The user can be added to the one or more communities of interest network. Certain implementations may include identifying one or more related community of interest networks based on the one or more preferred community of interest networks, the one or more related community of interest networks associated with subjects related to subjects associated with the one or more preferred community of interest networks. The related community of interest networks may be provided to the user.

In certain implementations, the indication from the user is a keyword search. One or more communities of interest may be identified based on the keyword search. The user may be added to the one or more communities of interest. One or more subscribers can be identified for the identified one or more communities of interest. An indication may be provided to the one or more subscribers of the addition of the user to the community of interest.

In certain aspects of the implementations, the user provides the indication for content through a web browser. In certain aspects of the implementations, the indication from the user for content automatically adds the user to the community of interest associated with the requested content. In certain aspects of the implementations, the real-time communications interface facilitates live, interactive video between members of the community of interest network.

In certain aspects of the implementations, the live communications interface facilitates one or a combination of a text-based communications session, a voice-based communications session, a video-based communications session, or other online interactive communications session between members of the community of interest.

Certain aspects of the implementations may include activating a video session in the user's web browser, a video service system providing a live interactive two-way video between the user's web browser and the web browsers of other members of the community of interest network. In certain aspects of the implementations, the members of the community of interest network include one or more of a publisher of a website and users of the website.

In certain aspects of the implementations, the community of interest is one of a plurality of parameters for establishing the community of interest network. In certain aspects of the implementations, the one of the plurality of parameters is a second community of interest. In certain aspects of the implementations, the community of interest network is established by one or more of a plurality of parameters, the parameters including one or a combination of network activity, search keywords, tagwords, algorithms, webpage portion, website or webpage domains, uniform resource locators, uniform resource identifiers, cookie information, device type, CoIN lifetime, or operational times.

In certain aspects of the implementations, wherein instructions further comprise associating the content with a community of interest (CoI), the CoI used to establish the CoIN.

While generally described as computer implemented software embodied on non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF THE DRAWINGS

FIG. 1A is a schematic illustration of a system architecture for providing community of interest networks.

FIG. 1B is a schematic illustration of an example architecture for providing video communication services for community of interest networks.

FIG. 2 is a schematic illustration of an example system and process flow for publisher registration of community of interest networks and associated parameters with a live network provider.

FIG. 3A is a diagram illustrating an example architecture and process flow for a publisher to register for community of interest networks and associated parameters with a communications service provider.

FIG. 3B is a swim-lane diagram illustrating an example process flow for a publisher to register for community of interest networks and associated parameters with a communications service provider.

FIG. 3C a swim-lane diagram illustrating another example process flow for a publisher to register for community of interest networks and associated parameters with a communications service provider.

FIG. 4A is a schematic illustration of an example system for providing communication services for a community of interest network from a communications service provider to a web browser.

FIG. 4B is a schematic illustration of an example system for providing communication services for a community of interest network from a communications service provider to a mobile phone.

FIG. 5 is a schematic illustration of an example system for a login to a community of interest network.

FIG. 6 is a schematic illustration of an example system to support online web services between a communications service provider and multiple browsers.

FIG. 7A is a swim-lane diagram for joining a communications interface associated with a community of interest network.

FIG. 7B is a swim-lane diagram for attaching to a community of interest network.

FIG. 8 is an example screenshot of a webpage acting as a web anchor for a community of interest.

FIG. 9 is an example screenshot of the webpage of FIG. 8 showing the organization and display of users of the community of interest network associated with the webpage.

FIG. 10 is an example screenshot of the webpage of FIG. 8 showing a notification of services associated with the community of interest network.

FIG. 11 is an example screenshot of the webpage of FIG. 8 showing a share functionality for the community of interest network.

FIG. 12A is an example screenshot of a news article webpage acting as a web anchor for a community of interest.

FIG. 12B is an example screenshot of a community of interest network for the news article webpage of FIG. 12A.

FIG. 12C is an example screenshot of a share functionality associated with the community of interest for the news article webpage of FIG. 12A.

FIG. 12D is an example screenshot of the share functionality associated with the community of interest for the news article webpage of FIG. 12C. FIG. 13A is an example screenshot of a first webpage highlighting an embedded advertisement that acts as a community of interest network anchor.

FIG. 13B is an example screenshot of a second webpage with the embedded advertisement shown in FIG. 13A that acts as an anchor for the community of interest network associated with the advertisement.

FIG. 13C is an example screenshot of the webpage of FIG. 13A with another embedded advertisement highlighted that acts as a community of interest network anchor.

FIG. 14A is a swim-lane diagram showing an example process flow for registering for communication services and community of interest parameters and providing community of interest services from a communication services provider.

FIG. 14B is a swim-lane diagram showing an example process flow for registering for communication services and community of interest parameters and providing community of interest services through a publisher.

FIG. 15 is a swim-lane diagram showing an example process flow for registering and providing CoIN services using advertisements.

### DETAILED DESCRIPTION

The present disclosure describes the configuration, creation, use and tear-down of ad-hoc, transient, real-time communication services for a dynamic Community of Interest Network (CoIN). A CoIN is a network of users who are sharing a particular common interest in content, service, location or device. Such common interests may be referred to as a Community of Interest (CoI). In certain embodiments, the methods, systems, and devices described herein provide for an Internet-website-embedded, autonomous video, voice, and data meeting place that allows any visitor to the website to participate in a real-time interaction with one or more members of a CoIN associated with the website, portion of a website, or content shown on a webpage, such as an advertisement.

At a website visitors are typically unaware of other visitors to that website. As such, the association between website visitors is both instantaneous and transient and the awareness of far-end party numbers does not exist. As a result, there is no mechanism for a website to initiate a call and bridge visitors to the website into the call. Also, no set of services has been defined for such a communication.

A website is typically visited by users and developed and managed by a publisher. Various CoIs can be defined by the users, or publishers. Examples of such CoIs include, but are not limited to, the following:

a) Visitors/publishers of a website;

b) Visitors/publishers of a part of a website;

c) Visitors/publishers in a particular geographic location area (e.g., users in the vicinity of an airport);

d) Visitors/publishers of a website or part of a website in a particular geographic location area (e.g., users of social media site in the vicinity of the Louvre Museum (Paris, France));

e) Users who are watching the same TV channel (via cable, satellite, or Internet);

f) Users who are listening to the same audio channel (via radio, satellite, or Internet);

g) Users who have entered the same keywords in a particular search engine;

h) A service where publishers (users) register for keywords, the entry of which will list them (their webpage) in the search. Each of these listings will create their own community of interest. (e.g., John Doe, Eye doctor from Plano, Tex. will register for keywords of Optometrist, Ophthalmology, Eye Doctor+Plano, Tex.; any search engine resulting in John Doe's listing will also dynamically create a CoI for John Doe);

i) Search results on keywords or people search create a CoI (e.g., All those searching Jane Doe on a social networking site)

j) Individual-specific CoI (e.g., www.hubpages.com/janedoe or www.linkedin.com/johndoe);

k) Users watching the same video clip on any of the video streaming sites; and

l) Algorithmic filters: search words entered in the search engine that are related, resulting in the same search.

In certain embodiments, the systems, methods, and devices described herein facilitate the creation of a virtual, real-time communication network between two or more users visiting an Internet website (or portion of a website) or between one or more users visiting a website (or portion thereof) and publishers of the website. These website visitors and website publishers may have not had any prior association or exchange of information.

The term “real-time” implies that, while data need not be provided instantaneously, it is provided without any intentional delay, taking into account the processing limitations of the system and the time required to accurately measure the data. For example, video frames should be rendered and ready at or before the frame is required for display. The output of a computer process (i.e., rendering) is presented to the user in real-time so that the user observes no appreciable delays that are due to computer processing limitations.

This disclosure describes providing video/voice/text communication to facilitate an increase in service breadth by enabling the video/voice/text communication to be anchored by a website (or various parts of the website), rather than being initiated by an endpoint. In this manner, video services can be consumed between endpoints that would not have been previously able to communicate. This disclosure also facilitates web-driven interaction of the parties. By tying the video interaction to an Internet website, the disclosure provides for an enhanced set of contexts of video interactions. For example, website visitors to a “department” of an online retailer can join into the live video interaction of that section of the website, and have a live visual interaction with other visitors in the same “department,” as well as with the website publishers in charge of that department.

Though described above in connection with a website, the subject matter disclosed herein is not limited to websites. For example, a community of interest network can be established and the communication services offered through other mechanisms, including, but not limited to television set top boxes, software running on netbooks, tablets, mobile phones, smartphones, or other portable devices capable of accessing the Internet or other communications network. Communication services include, but are not limited to voice, video, instant messaging, SMS, MMS, voicemail, text chat, e-mail, etc.

The present disclosure also describes achieving scalability by, for example, separating participants into creators and consumers of communications services traffic during a group interaction. Resource allocation is optimized, as well. Because service resources (such as directory storage, or switch processing capacity) are not pre-allocated, the present disclosure includes optimizing resource allocation by, e.g., matching the service size to the resource requirement at the time of service delivery.

In certain implementations, a web business/brand can deploy the CoIN for each of their “departments” (each department may correspond to a website or webpage, or a portion thereof). In certain implementations, a search engine or search toolbar on browsers can deploy a CoIN for various search terms (e.g., keywords) and/or the search results. In certain instances, a portal, such as Facebook, or Twitter, or Google+, can define various CoINs related to various keyword or trending events (e.g., Formula 1, NFL, etc.), and display these CoINs as a button to access the network on the users' webpages whenever such a Keyword appears on their pages/walls/chats/tweets/messages/etc. A browser, plugin, or Helper Object can look at the webpage content, the URL, and other information being browsed by the user and apply a CoIN filter to it to provide CoIN access options to the user. For example, users who are looking at the name “John Doe” can be provided a link to access John Doe's CoIN. In certain implementations, users (individual or business users) of various portal sites such as Facebook, Twitter, Google+, etc., can subscribe to, define, and create their own CoINs. Other visitors to the user's page or wall can access the user's CoINs.

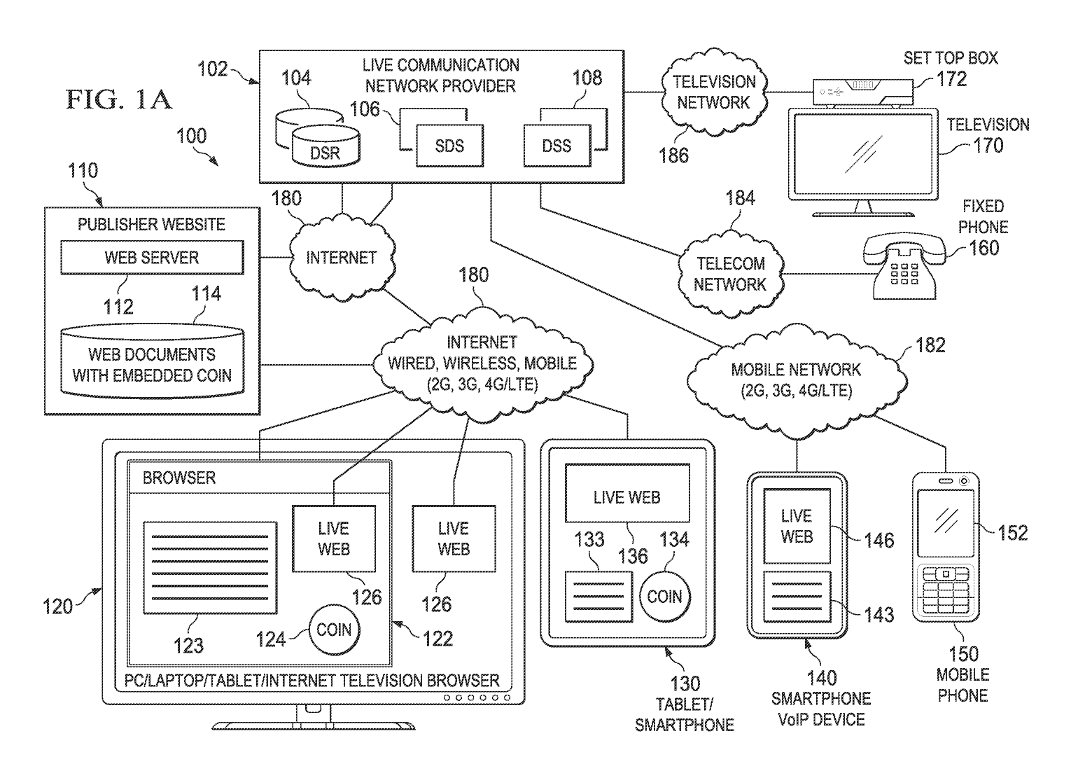

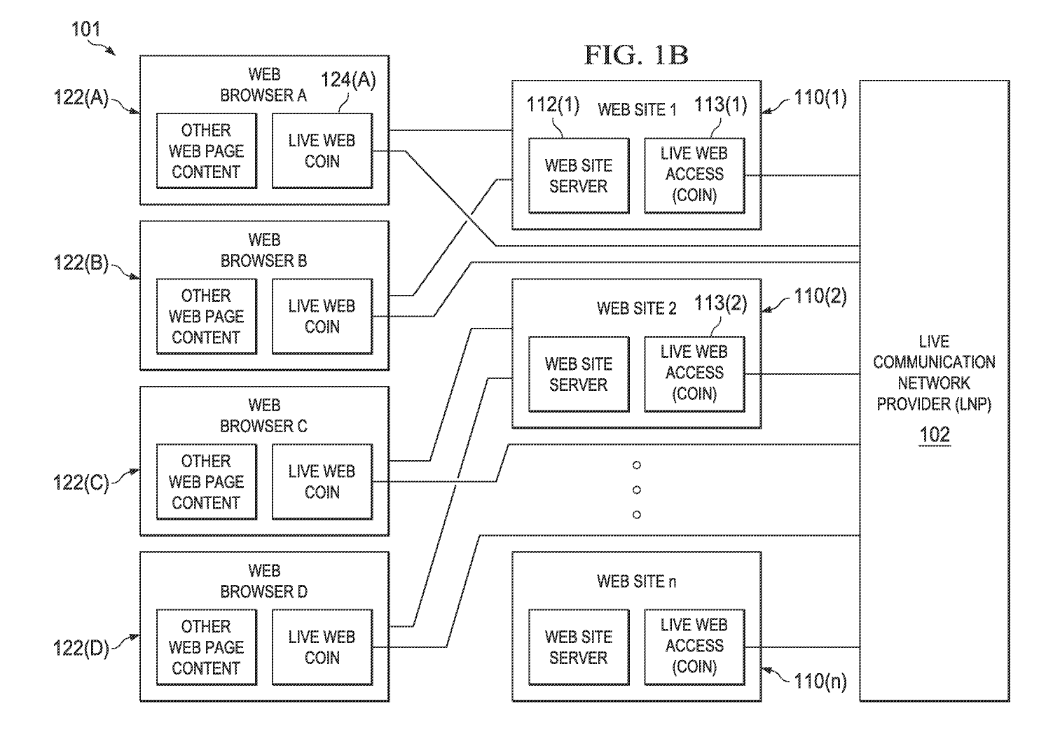

FIG. 1A is a schematic illustration of a system architecture for providing community of interest networks. The system 100 of FIG. 1A illustrates an example telecommunication network architecture for providing a community of interest network. FIG. 1A includes a Live Communications Network Provider (LNP) 102, a publisher 110, and users 120, 130, 140, 150, 160, and 170. The users are shown for illustrative reasons, and FIG. 1A is not meant to limit the number or type of users. Furthermore, the term “users” in this disclosure may refer generally to individuals using hardware and/or software to request, access, join, participate in, create, CoINs or CoIN services. The term “users” may also refer to the devices being used to perform such activity. FIG. 1A also shows a telecommunications network 180, which represents a wired or wireless communications network, such as the Internet, an intranet, WAN, LAN, mobile network (2G, 3G, LTE, WiMax, etc.). Network 186 is also shown and is meant to depict a television network. It is understood that the television network may be accessed across the Internet.

FIG. 1A shows a Live Communications Network Provider (“LNP”) 102 that provides various one-directional and bi-directional communication services to the users and publishers in its domain. Such communication services include, but not are limited to, voice, text, and/or video communications. For example, communications services can include voice, text, and/or video communications between any two users; voice, text, or video communications between multiple users; broadcast services of voice, video, and/or text to users or a subset of users of the CoIN; store and forward of voice, video, text mails; one-on-one communication services with a publisher or a publisher's agents; one-on-one communication services between users of a CoIN that has more than two users (e.g., private messaging, private chat room, etc.); public and/or private group/multi-party communication sessions; Centrex services; notifications (voicemail, messaging services, SMS, MMS, calendar alerts, e-mail, etc.); and any other such services as provided by existing telecommunications, mobile, or Internet-based communications systems.

LNP 102 includes Dynamic Service Register (DSR) 104, Service Discovery Server (SDS) 106, and a Dynamic Service System (DSS) 108. DSR 104 is responsible, in general, for registration processes between the LNP and publisher 110. Registration processes, described in more detail below, include receiving registration information from publisher 110. Registration information can include, but is not limited to, community of interest (CoI) and other parameters used to identify and/or establish a CoIN (CoIN profile), such as network activity including search keywords, tagwords, algorithms, webpage portion, website or webpage domains, uniform resource locators/identifiers, cookie information and/or other historical information, device type, CoIN lifetime or operational times, etc.; communication services for a particular CoIN and/or authorized enhancements thereto; default settings; billing information; user information (e.g., preregistered); location information; content type; marketing information, such as target markets; bandwidth limitations; contact information (e.g., for CoIN publisher or agents who participate in CoINs; coding or other resources for automated communication systems (e.g., bots, messages for voicemail services, etc.); and other information. DSR 104 may also receive application programming interface (API) keys associated with a publisher 110 and/or a CoIN for a publisher 110. Other information includes service keys, validity information, and authentication information, among other things.

System 100 facilitates the publisher service registration. A publisher can initiate a service registration by sending service parameters, API key, and identification details. A publisher can create a dynamic community of interest. The publisher can do so by using an embedded code and corresponding tokens to establish network services for a Dynamic Community of Interest. The system 100 also facilitates access and use of dynamic Cols. A visitor to Website A, which has been enabled for dynamic CoI services by a publisher, can enter the community and integrate in the communication flows that have been assigned to the CoI.

The system 100 may include a Dynamic Home Register (dynHR) that includes a Network Register (NR) where a publisher registers the type of network services that it requires for a specific dynamic CoI it expects to serve. The dynHR also includes a User Register (UR), where a visitor to a Web Page who is interested in participating in the Dynamic CoI registers to become part of the communication service.

DSS 108 is responsible for validating a publisher's request to establish a network service, exchanging billing and service parameters, and allocating an embedded code that is later used to associate a dynamic CoI with a network service. DSS 108 also provides the network service requested by the members of CoIN.

SDS 106 is responsible for identifying one or more communications services associated with a CoIN. Communications services may be assigned to a CoIN based on a registration process, whereby a publisher or other creator of a CoIN defines the communications services offered for that CoIN. Communications services can also be allocated dynamically. For example, SDS 106 may interpret commands, requests, suggestions, etc., from a user communicating in a CoIN and provide other communications services on an ad hoc basis. For example, a user of a CoIN may suggest to another user using textual services that video conferencing would be helpful. SDS 106 can be configured to receive that request using keyword identifications or other semantic process to (a) identify the statement as a request for video conferencing services, (b) identify whether video conference services are within the set authorized communications services for the publisher, (c) provide a notification to the CoIN users that video conferencing is available, and (d) provide an interface for video conferencing to the users (or a portion thereof) of the CoIN. Other events may occur, and the ones listed here are examples of steps that may occur to provide communications services dynamically. SDS 106 also maintains the table or list of network services subscribed by each CoIN, and the associated DSS 108 that will provide the specific network service to the members of the CoIN.

For example, a CoIN may have subscribed to multiple network services such as Video Broadcasting, and Multi-party Video Conferencing. The SDS 106 assigns and maintains a list where Video Broadcasting (network service) is supported by DSS 1, and Multi-party Video Conferencing (network service) is supported by DSS 2. When any member of the CoIN attaches to the CoIN, or invokes a network service, the SDS 106 provides the access information to the respective DSS 108 to the member. The DSS 108 then provides the actual network service to the member of the CoIN.

System 100 also includes a website/content publisher 110. Publisher 110 is a publisher of any website, online web content provider, or online web service provider, or any agent of a content/service provider. Publisher website 110 may be associated with a repository 114 that stores web documents, data, etc., and a web server 112. A publisher may define one or more CoINs. Each CoIN is represented by an array of parameters such as, a web-session between the user's end device and a particular web server, or part of a web service; a web-session between the user's end device and a website (e.g., www.xyz.com); a web-session between the user's end device and a part of a website (e.g., www.xyz.com/department/laptops/customercare); a web-session between the user's end device and a web-based service provided by a website (e.g., www.banking.com/mybanking.cgi). Any such web-based service may be provided by using web technologies such as HTML, DHTML, PHP, CGI, ASX, Flash, Javascripts or any other scripting/web programming languages either driven by client-side, or server-side scripting; a web-session where the user is searching for keywords “Patent Attorneys in Bay Area” on a popular search engine(s), and is in the Bay Area location; the location of the end-user device; and the type of the end-user device.

System 100 includes one or more users or consumers of content/service who are using the Internet or the mobile network to access a particular content or service provided. System 100 shows six device types, which can each be considered a user. For example, user 120 may be a PC, laptop, MAC, tablet, or Internet television, or other device used to access a network 180. User 120 may include a browser 122 that can be used to display a CoIN interface 124, an interface for live or streaming content 126, and an interface for browsing other web content 123. User 120 may also be configured to provide a stand-alone live web interface 126.

User 130 is shown as a tablet PC or smartphone device that communicates with the network 180 through a telecommunications network. User 130 may include a browser that can be used to display a CoIN interface 134, an interface for live or streaming content 136, and an interface for browsing other web content 133.

User 140 is a smartphone that communicates across a mobile network 182 using voice over Internet protocol (VoIP) functionality. The device of user 140 may include an interface 143 and a live web interface 146. A live web interface 146 is a window or display space on the user's end device which is displaying or playing or capturing live media to/from the user's end device.

User 150 is a mobile phone that communicates across the network 182. User 150 includes a communications interface 152. User 160 is a telephone that communicates through a telecom network 184. User 170 is a television system that includes set top box (STB) 172. STB 172 communicates through a television network 186, such as a cable network or a satellite network.

Once registered or attached to the CoIN, a user can invoke and use communication services provided by the CoIN. Users can also specify the device by which CoIN services are to be accessed. For example, a user can use a laptop to access a webpage, and when invoking CoIN services, can specify that such services are to be delivered to his or her cellular phone. The CoIN service can then be delivered to the cellular phone for this session and, if selected, as a default for future sessions.

FIG. 1B is a schematic illustration of an example architecture 101 for providing video communication services for community of interest networks. In FIG. 1B, a Web Browser A 122A, which can view content stored on a website server 112(1) associated with Website 1 110(1). Similarly, there is Web Browser B 122(B) also viewing content from Website 1 110(1). There can be several Web Browsers, e.g., Browser C 122(C) and D 122(D), viewing content from several other websites such as Website 2 110(2). Website 1 110(1) obtains the web video services from LNP 102 acting as a web video service system using hypertext transfer protocol (HTTP) or any other IP-based interface connectivity. In certain embodiments, the LNP 102 provides a Web Video Interface for the Website 1 110(1) to embed into the webpage.

When Web Browser A 122(A) accesses the Website 1 110(1), the Website 1 110(1) delivers the Web Video Interface along with other content of the webpage to Web Browser A 122(A). The Web Video Interface in the Web Browser A 122 (A) provides connectivity and access to the Web Video Service system using the HTTP or any other IP based connectivity. Live Web CoIN 124(A) may be used as an interface to interact with other CoIN members using the web video interface delivered by Website 1 110(1).

When Web Browser A 122(A) is viewing the webpage content from Website X, it is added to the dynamic community of interest network of Website 1 110(1) in the LNP 102. Web Browser A 122(A) can then activate the Web Service Interface (for Live Web CoIN 124(A)) to enter into a Live Interactive video session with all other members of the community of interest of Website 1 110(1) by sending messages to the LNP 102.

Website 1 110(1) can be any page or all pages on a particular website. For example, all pages in the domain name www.amazon.com can be referred as Website 1 110(1), or a particular page on that site (e.g., http://www.amazon.com/Childrens-Books/xxxx . . . ) can be referred as Website 1 110(1).

The dynamic CoI that is created is for the Website 1 110(1) as described above. This includes all such Web Browser A 122(A) visiting the Website 1 110(1), including visitors, and publishers of the Website 1 110(1). When the video session is activated by the Web Browser A 122(A), the LNP 102 provides a live interactive two-way video between all such web browsers that are part of the same CoIN. A text chat session, or a voice session, or any other interactive session can be initiated by the Web Browser A 122(A) using the LNP 102 system for that particular CoIN.

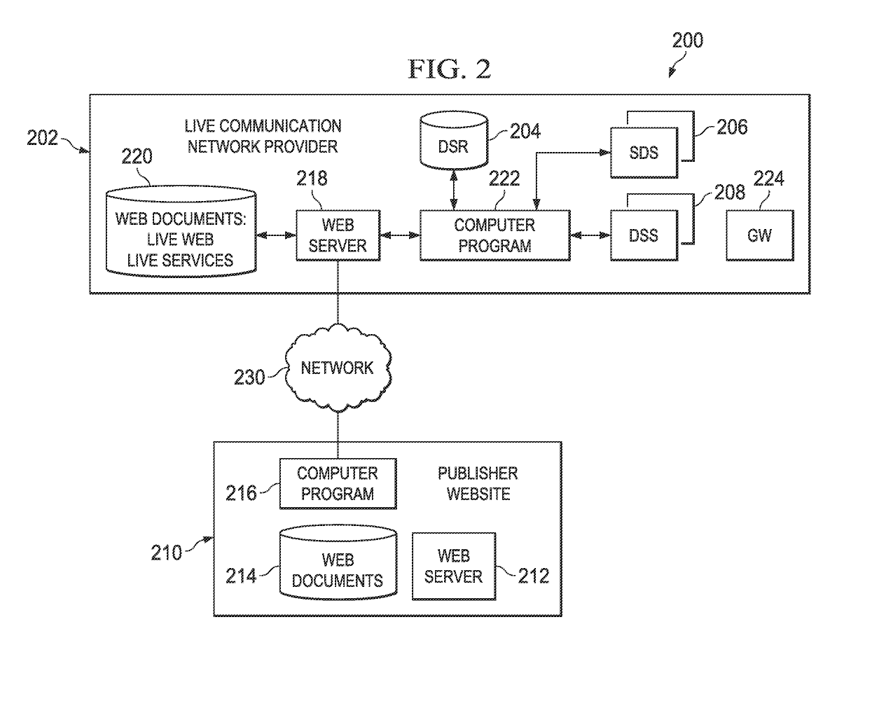

FIG. 2 is a schematic illustration of an example architecture and process flow for publisher registration of community of interest networks and associated parameters with a live network provider. In certain implementations, a publisher can register with the LNP for CoIN services. Registration facilitates the building of a trust relationship between the publisher and the LNP. Publisher registration involves the registration and exchange of API keys, CoIN keys, service keys, billing information, CoIN profile information, authorized communication services, user fee structure information, security and privacy information, listings of registered users, demographic information, marketing information, and other information. CoIN profile information includes any information used to create, identify, store, and/or provide a CoIN. Such information includes, but is not limited to part of a web document, location, keywords, tag words, algorithms (e.g. algorithms for combinations of keywords, related keywords, device type, tag words, etc. to build a semantic model), web domain, device type, lifetime/time of day, user's web session information, including cookies, historical online activity, and other network activity.

FIG. 2 shows an LNP 202, similar to that of LNP 102 of FIGS. 1A-1B, and a publisher 210. LNP 202 includes a DSR 204, SDS 206, and DSS 208, all of which are in communication with a computer program 222. LNP 202 also includes a repository 220 that stores, among other things, web coding that provide live web and live services. LNP 202 also includes a web server 218 that communicates across network 230 with the publisher 210. LNP 202 also includes a gateway (GW) 224 for communicating with other types of networks. Publisher 210 includes a publisher web server 212, a repository 214, and a computer program 216 that can act as an interface for communicating with web server 218 of the LNP 202.

The publisher 210 establishes a trust relationship with the LNP 202, and requests an API key, billing key, CoIN-key, and authentication parameters for a particular CoIN. The LNP 202 provides a unique API/billing Key, CoIN-key, and authentication parameters for the registered CoIN for the publisher 210. The LNP 202 also provides a suite of services available in the CoIN for the publisher 210, and the respective tariff and billing information. The publisher 210 requests a subscription to specific services, and obtains a service key for each requested service available in the CoIN. The API-key+CoIN-key+Service-key become a unique identifier of a service requested by the publisher 210 for a specific CoIN. In certain implementations, the LNP 210 can provide embedded code or web service links or SDK/tools to allow for publisher 210 to include access to the CoIN and its services in their web content/service

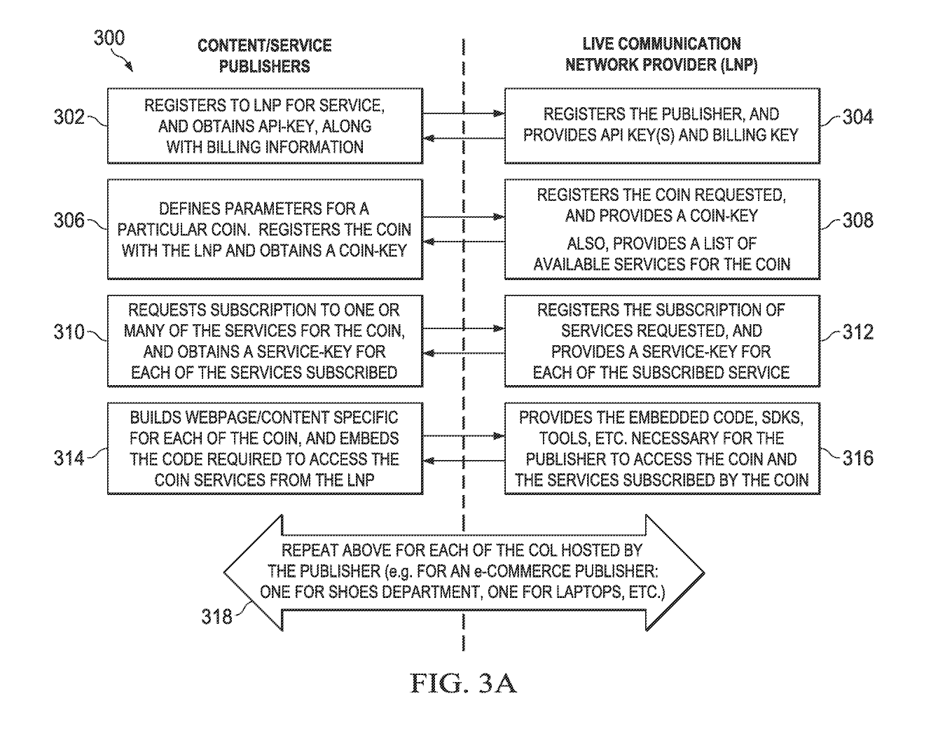

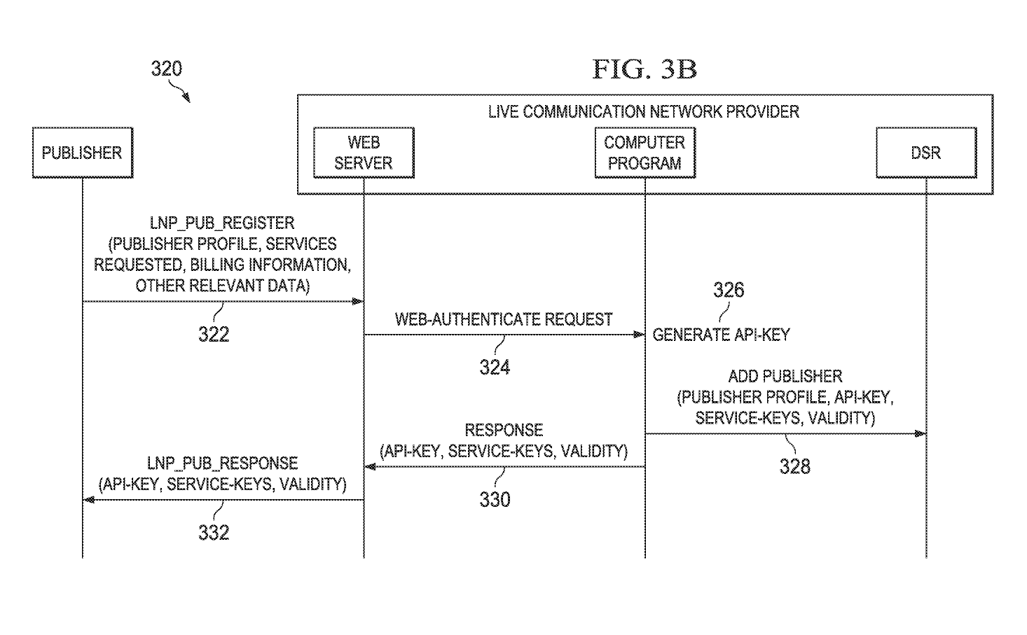

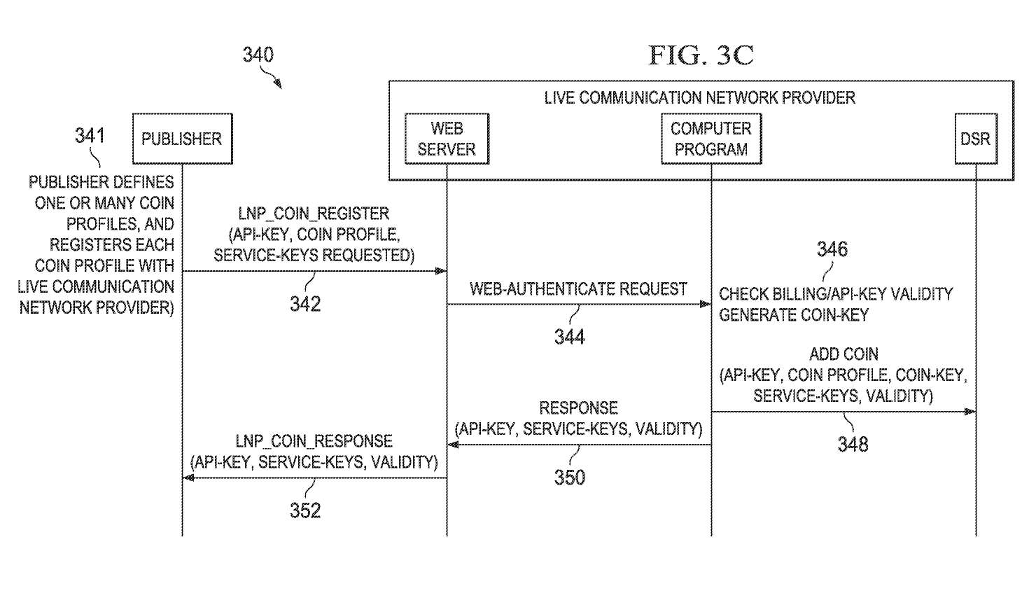

FIG. 3A is a diagram 300 illustrating an example process flow for a publisher to register for community of interest networks and associated parameters with a communications service provider. First a publisher registers to LNP for service, and obtains API-key, along with billing info (302). The LNP can register the publisher, and provides API key(s) and billing key (304). The publisher defines the parameters for a particular CoIN and registers the CoIN with the LNP and obtains a CoIN key (306). The LNP can register the CoIN requested, and provides a CoIN-key. Also, LNP provides a list of available services for the CoIN, which can be defined by the publisher or be limited by the publisher's authentication credibility (308). The publisher can request a subscription to one or many of the services for the CoIN, and obtains a service-key for each of the services subscribed (310). The LNP registers the subscription of services requested, and provides a service-key for each of the subscribed services (312).

In certain implementations, the publisher builds webpage/content specific for each of the CoIN, and embeds code required to access the CoIN services from the LNP (314). The LNP provides the embedded code, SDKs, tools, etc. necessary for the publisher to access the CoIN and the services subscribed by the CoIN (316). In other implementations, the publisher registers one or more webpages, and requests assignment of CoINs for each website, webpage, or portion thereof. In this situation, a user visiting the webpage can received a CoIN interface and CoIN services directly from the LNP.

The steps above are repeated for each CoIN hosted by the publisher (e.g., for an e-commerce publisher, the publisher can register a CoIN for a shoe department, and another for Laptops, etc.) (318).

FIG. 3B is a swim-lane diagram 320 illustrating an example process flow for a publisher to register for community of interest networks and associated parameters with a communications service provider. FIG. 3B and FIG. 3C provide structural detail to the described registration procedure. Diagram 320 shows a publisher interacting with the LNP, which includes a web server, a computer program, and DSR. The publisher registers with the LNP by communicating a request to the web server (322). The request can includes relevant registration information, such as a publisher profile, services requested, billing information, or other information. In some implementations, the publisher may request registration and be prompted by the LNP to provide the information (e.g., using a registration wizard or other form). The web server communicates the request to a computer program that communicates with the DSR (324). An API key is generated (326), and the publisher is added to the registry (328). Adding the publisher to the registry can include adding the publisher profile, API key, service keys, validity/authentication, or other information. Such information may be used to provide CoIN services and to uniquely identify the publisher.

The response of the registry is that the API-key, service keys, validity information (authentication), and other information is delivered back to the web server (330) for delivery to the publisher 332.

FIG. 3C a swim-lane diagram 340 illustrating another example process flow for a publisher to register for community of interest networks and associated parameters with a communications service provider. In diagram 340, the publisher can define one or more CoIN profiles, and register each one with the LNP. The publisher provides the CoIN profile for each CoIN and can request an API-key, service keys, and other information for each CoIN (342). The web server can authenticate the request (344). Upon authentication, the computer program can check billing and API key validity, and generate a CoIN key (346). A CoIN can be added using the API-key, CoIN profile, CoIN-key, service keys, and authentication information (348). The computer program may communicate this information to the server (350), which communicates it to the publisher (352).

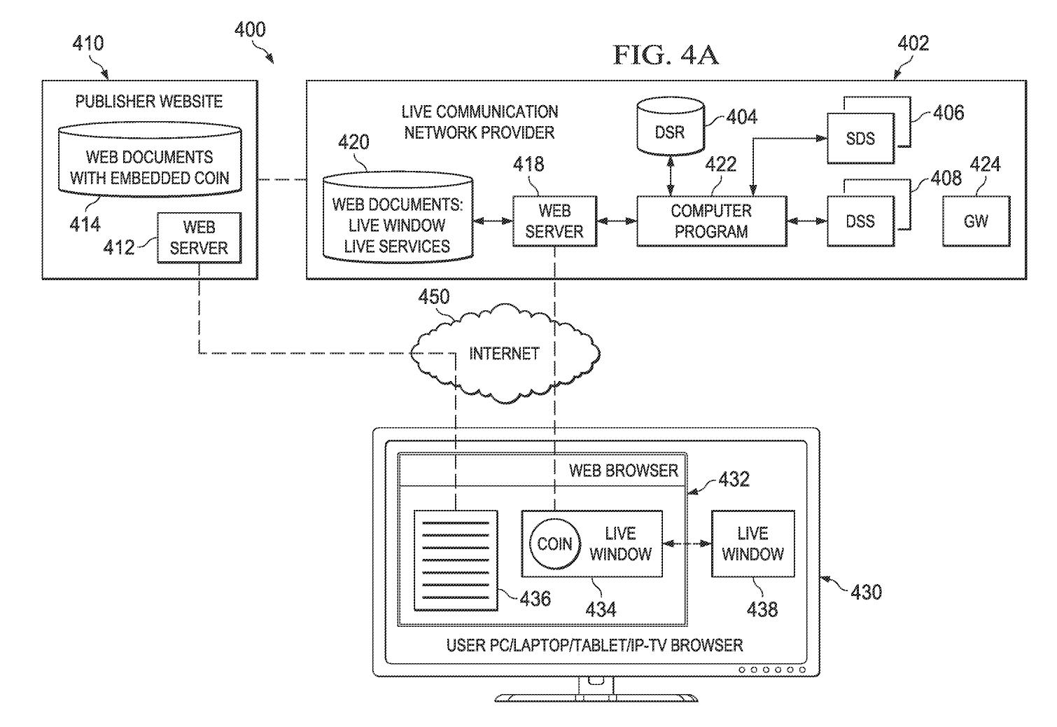

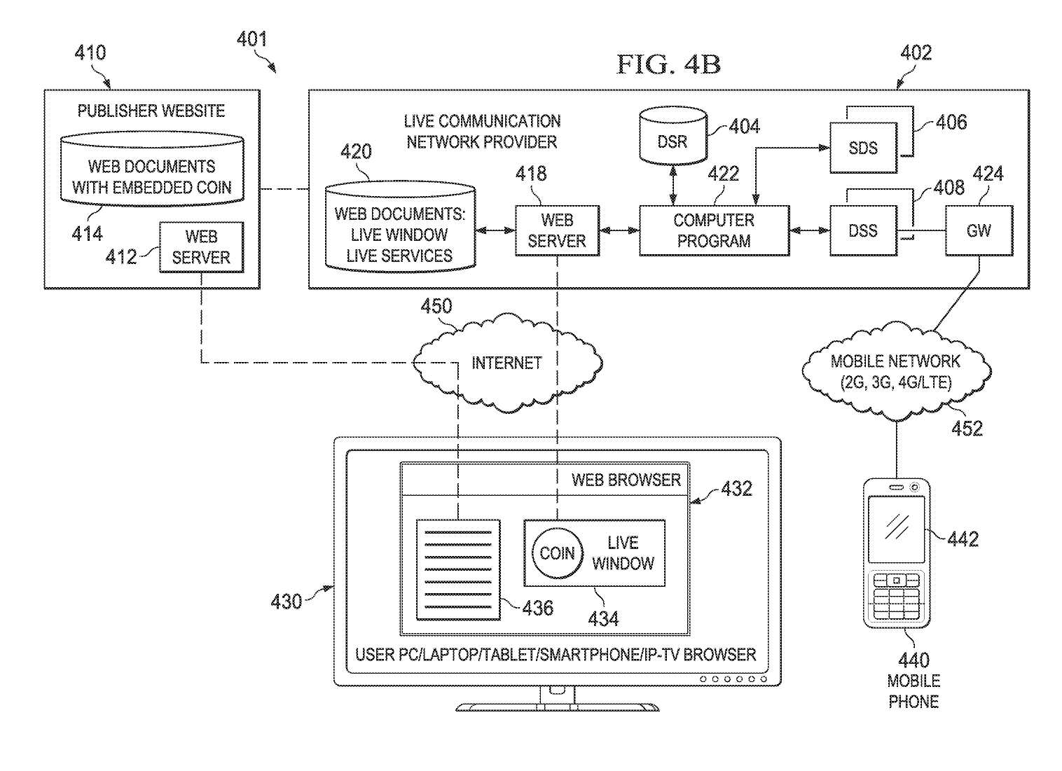

FIG. 4A is a schematic illustration of an example system 400 for providing communication services for a community of interest network from a communications service provider to a web browser. System 400 includes system components similar to those shown in FIG. 1A. System 400 includes an LNP 402, a publisher 410, and a user 430. LNP 402 includes a web server 418 that communicates to user 430 across a network 450. Web server 418 may also communicate with publisher 410 through the Internet or by other networks. LNP 402 includes a repository 420 for storage of web documents. A computer program 422 may be executed to perform certain functions, and may communicate with DSR 404, SDS 406, and DSS 408. A gateway 424 may also be included for communications with other types of networks.

Publisher 410 includes a web server 412 and a repository 414 for storage of web documents, which may include embedded CoIN coding. Repository 414 can also store authentication information, API keys, service keys, CoIN profiles, user profiles, and other information used to identify, create, register, provide, and otherwise facilitate CoINs.

In system 400, the user is user 430, which is any user that includes a web browser 432 for browsing the Internet. For example, user 430 may be a PC, laptop, tablet, IP-TV browser, gaming system, MAC, etc. Web browser 432 can be used to browse content 436, and can be enhanced using embedded code delivered from a publisher or delivered directly from the LNP 402. Browser 432 can include an embedded window 434 that provides an interface that allows the user to view, join, and interact with the CoIN. LNP 402 can also provide an interface window 438 to the user, either as a new window or as an executable program downloaded from the LNP server 418.

In FIG. 4A, a user 430 accesses a publisher website 410 using a web browser 432 or an App on PC, Laptop, Smartphone, Tablets, or IP-TV Browser. The web server 412 of the publisher's website 410 sends web documents stored in the repository 414 to the users' browser/app 432 that includes the CoIN attributes and access keys. The user 430 can view CoIN options and services by moving the mouse over (mouse hover) or clicking on the CoIN icon. A user can access the CoIN by logging in using his/her preferred credentials to access COIN services.

The user 430 may click on the default CoIN service (public video room). The CoIN interface 434 in the user's web browser 432 sends the service request to the LNP web server 418 with CoIN Keys, User Session Keys, Service Key, User Login Credentials, Preferred Device, Current Device, Location, etc. The LNP web server 418 will pass the service request to the computer program 422. The computer program 422 will authenticate the service request using the DSR 404. If successful, the computer program 422 will obtain the serving switch ID and address from the SDS 406, and route the service request to the DSS 408. The DSS 408 will start the live session with the live window in the user's browser/app. DSS 408 will exchange messages with the CoIN/browser/app. via computer program 422 and LNP web server 418 to setup the session. Live media will flow directly between DSS 408 and the browser live window 434 or on a stand-alone live window 438 on user's Laptop/PC/Smartphone.

FIG. 4B is a schematic illustration of an example system 401 for providing communication services for a community of interest network from a communications service provider to a mobile phone. System 401 includes the same elements as system 400, but also includes an additional user: mobile phone 440. Mobile phone 440 can communicate with LNP 402 through a mobile network 452 that interfaces with LNP via a gateway 424. The mobile phone 440 can be used to send and receive communications for the CoIN. In addition, a user can join a CoIN using the device shown as user 430 (e.g., PC, laptop, etc.) by visiting a webpage associated with publisher 410, and may request that the mobile phone 440 be a primary device. Subsequently, text messages, calendar alerts, notifications, voicemail, e-mail, or other messages that can be communicated through the mobile network can be delivered to the mobile phone 440. The LNP can send messages to the mobile device 440 to alert the user that a message is waiting, that a person has joined the CoIN, that a conversation is occurring between members of the CoIN, that there are updates to the CoIN services available, etc. Allowing such information to be communicated to a mobile device facilitates speedy notification of CoIN activity. The user can then opt to change the prioritized device at a later date. A set top box or television can also be used to establish/access a CoIN.

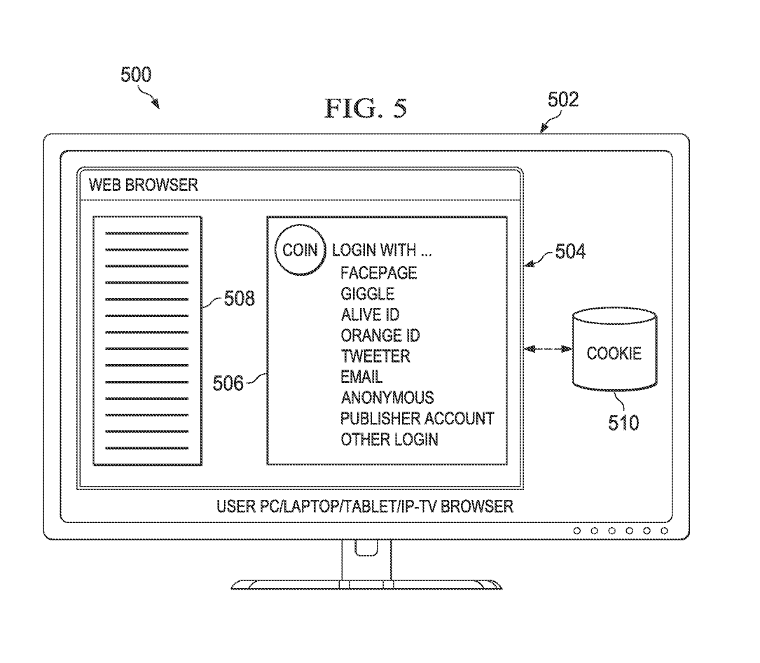

FIG. 5 is a schematic illustration of an example system 500 for a login to a community of interest network. System 500 shows a web browser 504 displayed on a computer display 502, such as a display for a PC, tablet, MAC, laptop, Internet TV system, gaming console, etc. The web browser 504 displays Internet content 508. It also displays a CoIN interface 506. CoIN interface 506, in this example, shows multiple ways for a user to log onto the CoIN. For example, interface 506 allows the user to log onto the CoIN using login credentials associated with social media, e-mail accounts, anonymously, or other login credentials. In certain implementations, a user profile can be created whereby the user provides login credentials for multiple e-mail accounts and social media, and creates a single-sign-on user name and password. By using a single-sign-on user name and password, the user can expand the realm of communications mechanisms. For example, the user can share a news article using both Facebook and Google+ using a single-sign-on to the CoIN. Returning users can be identified using login credentials. In certain implementations, a cookie 510 can also be used to identify a user. The cookie 510 can be associated with the publisher's website or may be associated with a different website that is associated with the CoIN, such as a social media website. For example, a cookie 510 identifying a user's Facebook credentials can be used to identify the user to the CoIN, thereby creating a more seamless browsing and CoIN experience.

Users accessing or interested in a particular CoI can become associated with the CoIN. Users can access a particular CoI using login credentials that are 1) anonymous, 2) login credentials provided by the CoIN owner, 3) Email/Password, 4) any other federated or social network login credentials such as Facebook, Gmail, Twitter, etc. Once registered/attached to the CoIN, users can invoke and use services provided by the CoIN. Once the user leaves the CoIN, he/she can detach/de-register from the CoIN, and can no longer access services provided by the CoIN. Once user returns to the CoIN, he/she is able to access the services again, as well as access stored messages, videos, text, voicemails, etc. Alternatively, the user can stay checked in after leaving, and receive notifications in, e.g., a task bar or on a mobile device, etc.

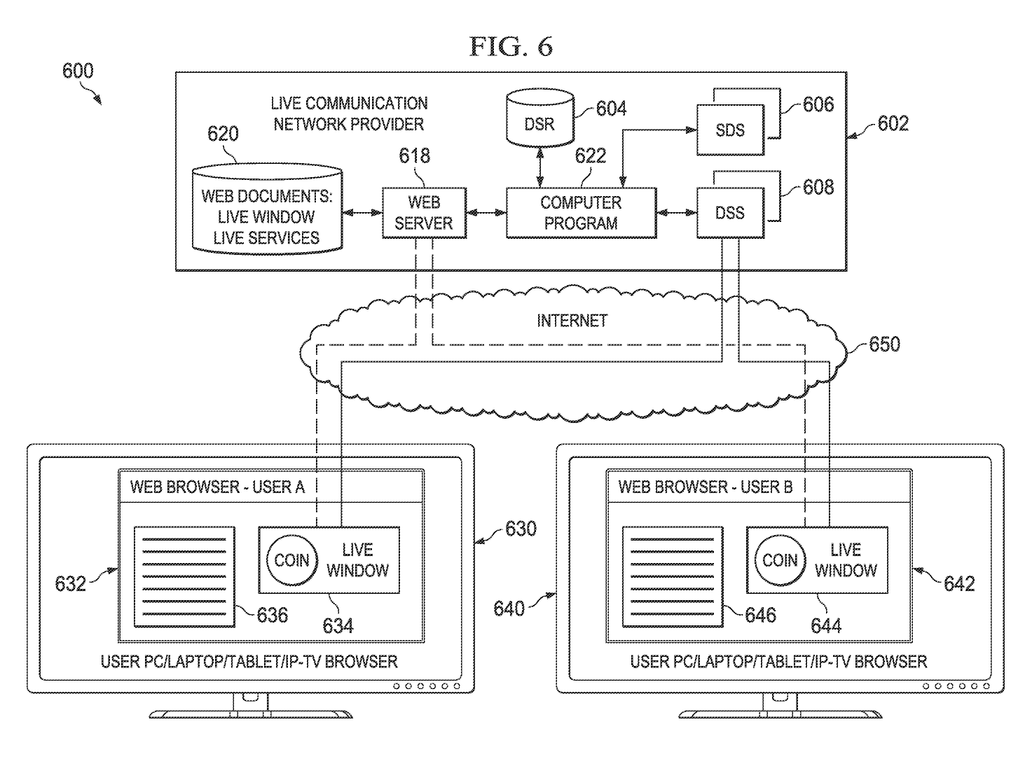

FIG. 6 is a schematic illustration of an example system 600 to support online web services between a communications service provider (LNP 602) and multiple browsers. System 600 includes system components similar to those shown in FIG. 1A but does not show the publisher. This example system 600 depicts an LNP providing CoIN services directly to users. System 600 assumes that a CoIN exists that users are attaching to. System 600 includes an LNP 602 and users: user A 630 and user B 640. Users A and B in system 600 are depicted as computers that have displays for displaying a browser. User A 630 displays a web browser 632. The web browser 632 shows web content 636 and a CoIN interface 634, the CoIN interface 634 configured to provide communication services across the network 650 to the users. Similarly, user B 640 includes a web browser 644 that can display web content 646 and a CoIN interface 646. LNP 602 includes a web server 618 that communicates to user across a network 650. LNP 602 includes a repository 620 for storage of web documents. A computer program 622 may be executed to perform certain functions, and may communicate with DSR 604, SDS 606, and DSS 608.

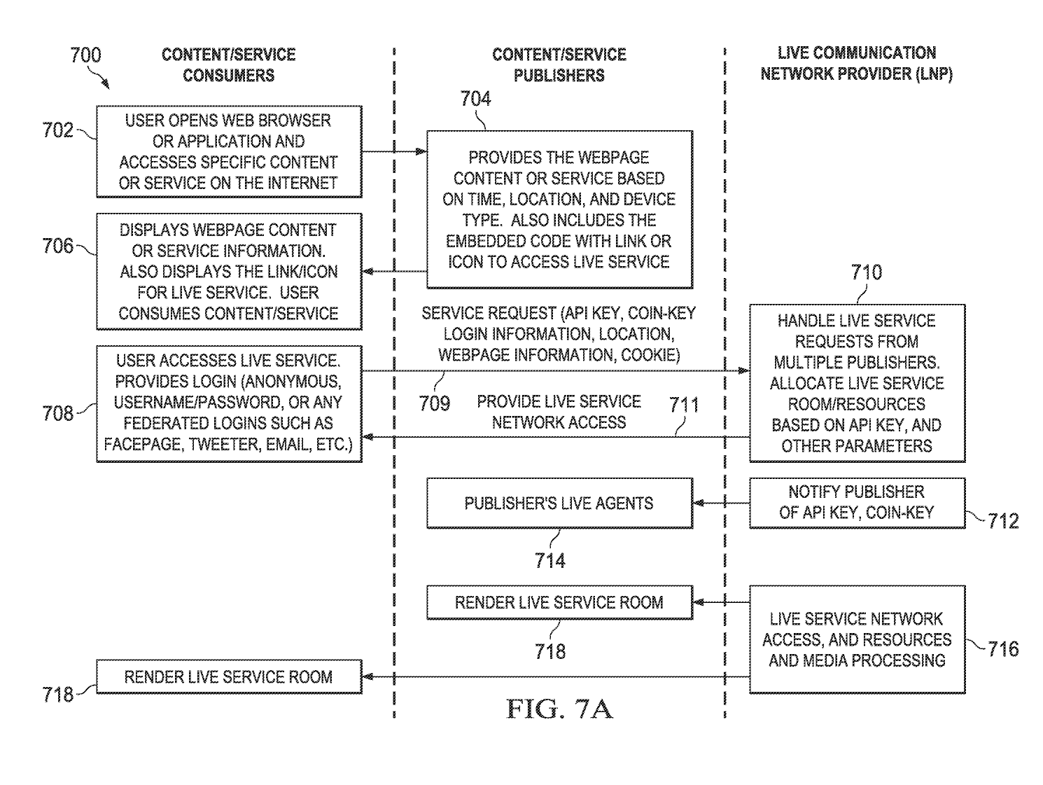

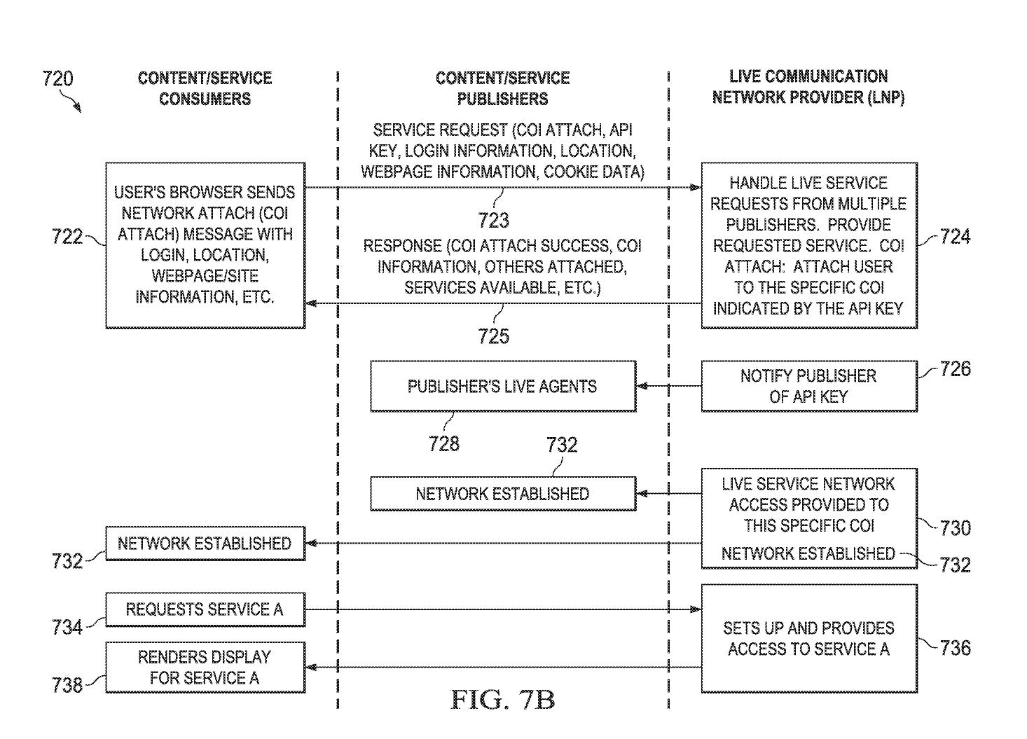

FIG. 7A is a swim-lane diagram 700 for joining a communications interface associated with a community of interest network. A user opens a web browser or application and accesses specific content or service on the Internet (702). The content publisher provides the webpage content or service based on time, location, and device type. Also, the webpage may include embedded code with links or icons to access CoIN services (704). The user is displayed the webpage content or service information. The user is also displayed the links or icons for CoIN services in situations where there are embedded code (706). A user can access the CoIN services (708). The user can provide login credentials or may log on anonymously. The request for services is provided to the LNP (709). The request is provided along with information associated with the publisher and the CoIN, including the API key, the CoIN key, login information, location, webpage information, cookies, etc. The LNP handles the service requests (710). LNP also allocates live service resources and rooms based on the API key and other parameters. The services can be provided to the user (711). In addition, the LNP can notify a publisher of the API key and the CoIN key (712). The publisher's live agents can join the CoIN to interact with the user (714). The LNP can also perform resources and media processing (716), and render a live service “room” to the publisher and the user (718).

FIG. 7B is a swim-lane diagram 720 for attaching to a community of interest network. First, a user's browser sends a Network Attach (CoIN Attach) message with login, location, webpage/site info, etc. (722). A Service Request (COI Attach, API Key, Login info, location, webpage info, cookie data) is transmitted (723) (in certain implementations, from a publisher). The LNP handles service requests from users and publishers (724) to provide the requested service. For the CoIN attachment: the user is attached to the specific CoIN indicated by the API Key received. A CoIN Attach Success response is transmitted 725, which includes CoIN Information, others attached, services available, etc.

The publisher and its agents are notified of the API Key (726), as well as the of the establishment of the CoIN (732) (or the joining of a new user to an established CoIN (728)). Communications services are then provided by the LNP for this CoIN (730). The network is then established (or the new user then joins the network) (732). A user may request a service (734). The LNP sets up and provides access to the requested service (736). The communications service interface is then rendered on the user display (738).

The publisher can establish an association between a CoIN and a list of available services for that CoIN and provide that associated to the LNP. A user accesses the publisher's website, content, or web service, where the parameters of the user's web-session overlap with or correspond to certain of the parameters of the CoIN (as defined by the publisher). For example, a user accessing a web-session at www.xyz.com/department/laptops/customercare using his laptop in Dallas, Tex. would exhibit network activity such as a particular URI (portion of a website), a device type (laptop), a location (Dallas, Tex.). These parameters may overlap with certain parameters associated with one or more CoINs, such as the CoIN associated with customer care for laptops. As another example, user in San Francisco, Calif. is searching for the keywords “Best Patent Attorneys in Bay Area” using his iPad. This user exhibits network activity associated with a keyword search and a device (iPad). The keyword search may prompt the LNP to identify one or more CoINs for patent attorneys in the Bay Area. Certain vendors may register for keywords so that when users search for keywords, the vendor's CoIN is one of the CoINs recommended to the user.

A user can register and attach to a CoIN. Once the parameters of the user's web-session matches or overlaps with the parameters of the CoIN, a request to attach/register the user to the CoIN network is sent to the LNP. Such a request is sent either by the web-browser using client-side scripting embedded in the webpage document, or by server-side scripting driven from the web server hosting the publisher's content/service, or via combination of both. Once the user is registered to the CoIN network, he/she is provided access to the services of the CoIN. Once user ends the web-session (e.g., the web-session parameters no longer match the CoIN parameters), the user is detached or unregistered from the CoIN. In certain implementations, the user can stay attached to the CoIN to follow the Coin session after leaving the session (e.g., shutting down the computer) by having the CoIN transfer the session to a different device, like a smartphone or tablet.

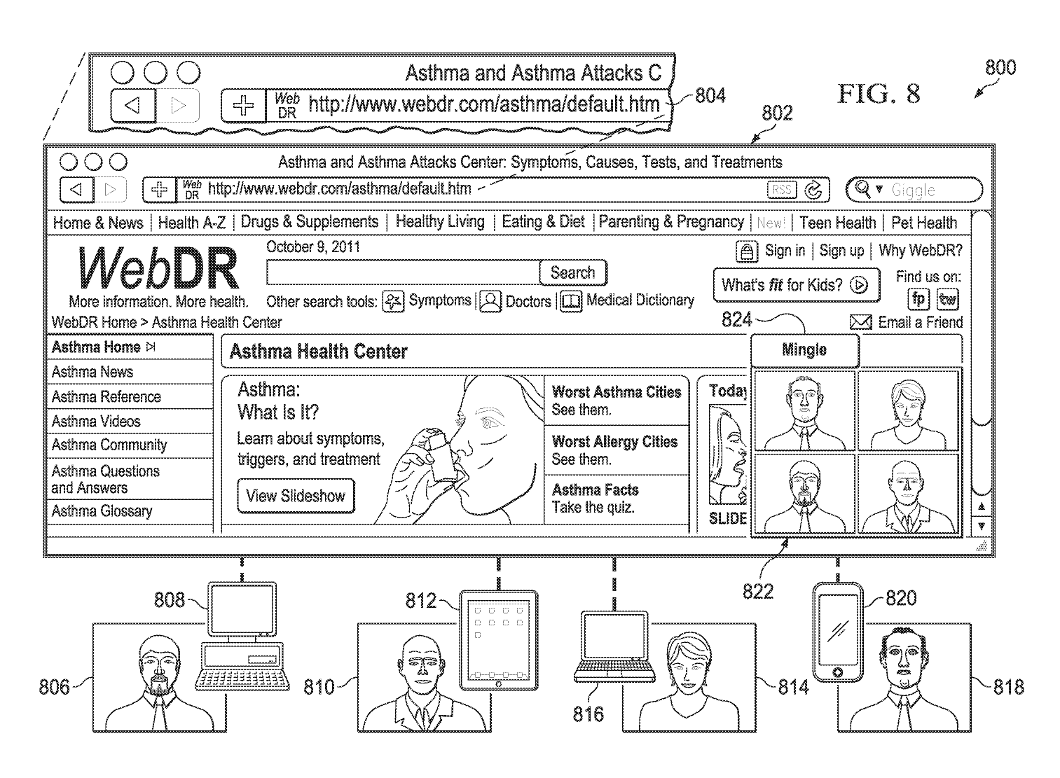

FIG. 8 is an example screenshot 802 of a webpage acting as a web anchor for a community of interest. The arrangement 800 shown in FIG. 8 shows a screenshot 802 of a webpage with embedded CoIN functionality. Arrangement 800 also shows users (and user devices) that can access and join a CoIN associated with the depicted webpage. In this case, user 806 visits the webpage 802 using a laptop 808; user 810 visits using a tablet 812; user 814 visits using a PC 816; and user 818 visits using a smartphone 820. Webpage 802 includes a URL 804. The users can access the CoIN and CoIN services by visiting the website. The CoIN interface 822 can provide communication services for the users on the CoIN. The services can be requested (and the CoIN can be accessed) by clicking or selecting the “Mingle” button 824.

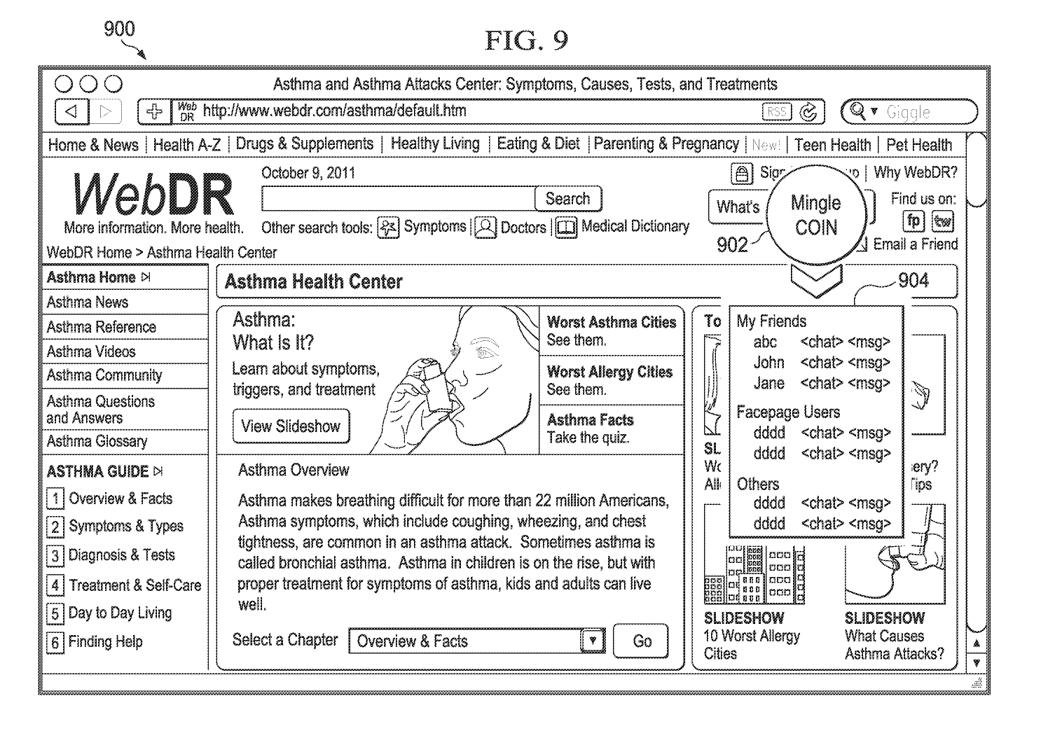

FIG. 9 is an example screenshot 900 of the webpage of FIG. 8 showing the organization and display of users of the community of interest network associated with the webpage. An icon 902 can be selected. Selection of icon 902 can display a list 904 of users who are associated with the CoIN or who are currently joined on the CoIN. Alternatively, the list of users can be dynamic, showing when users (or select users) join and drop off Or the list can show only friends, moderators, and CoIN creators.

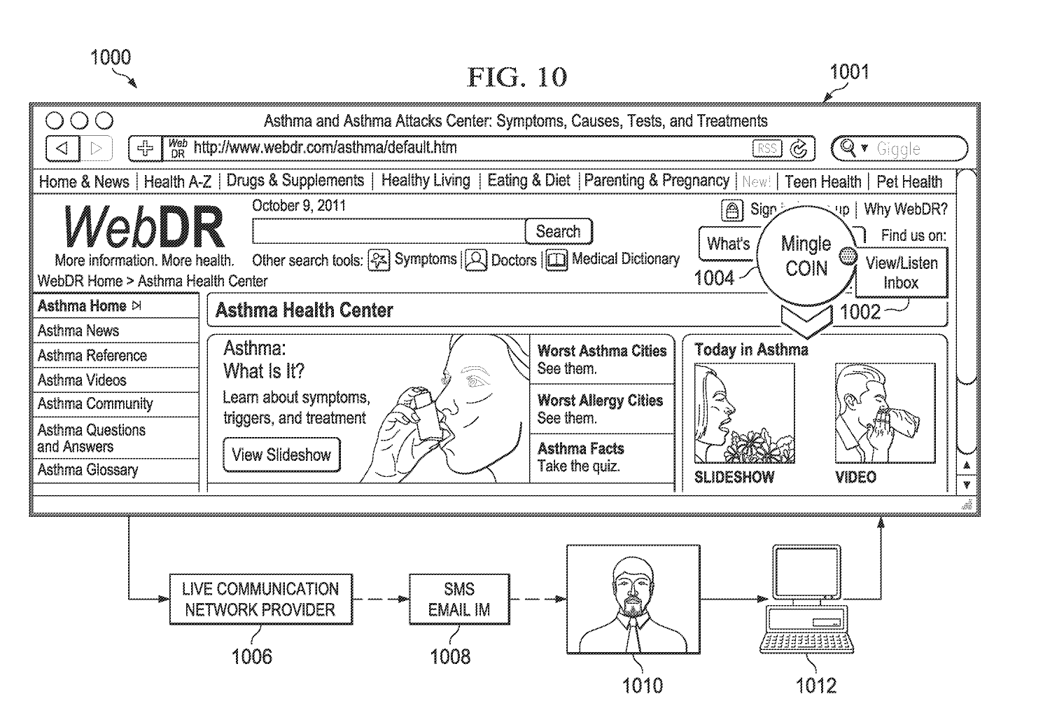

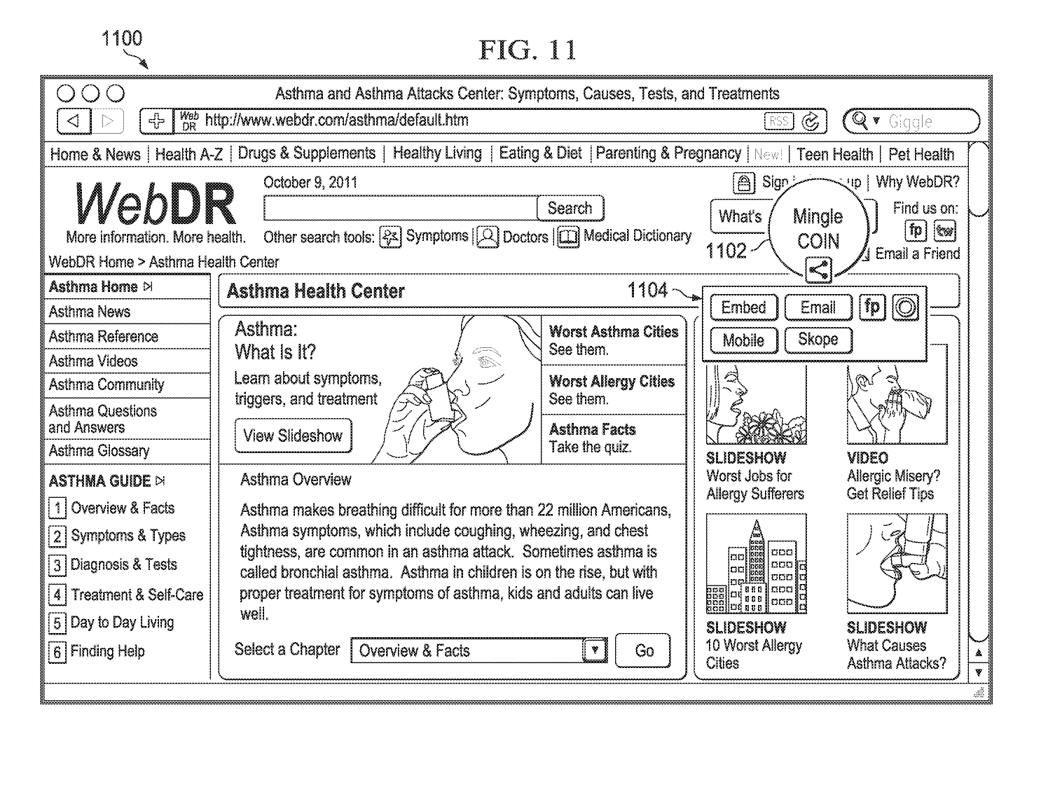

FIG. 10 is an example screenshot 1000 of the webpage 1001 of FIG. 8 showing a notification of services associated with the community of interest network. A user 1010 may receive a notification 1008 from the LNP 1006 that a private message was left for him on a CoIN. The message 1008 can be a voicemail, an SMS, an e-mail, and IM, or other notification indicator. The user 1010 can receive the message on a computer, mobile phone, smartphone, landline, or other communications device. The private message can include an indication of the CoIN, the webpage, etc, so that the user can retrieve the private message. The user can then visit the webpage using laptop 1012 and access the CoIN services through an icon 1004 to retrieve the private message from an inbox 1002. In certain implementations, and depending on certain privacy settings among other things, the notification message can include a part of or the whole private message.

FIG. 11 is an example screenshot 1100 of the webpage of FIG. 8 showing a share functionality for the community of interest network. The Mingle icon 1102 can be selected, which can prompt one or more options. One option is a share option 1104. The user can click on one or more share options. Sharing a CoIN includes an invitation to join, a notification of a CoIN's existence, a summary of the webpage content, or other information.

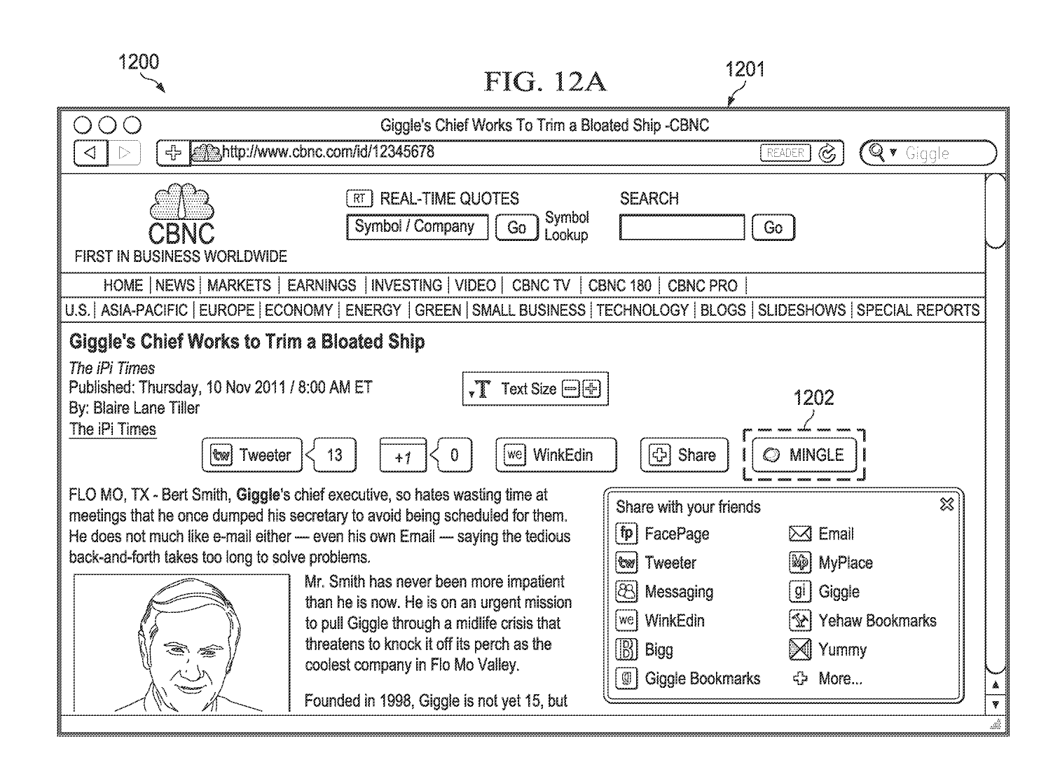

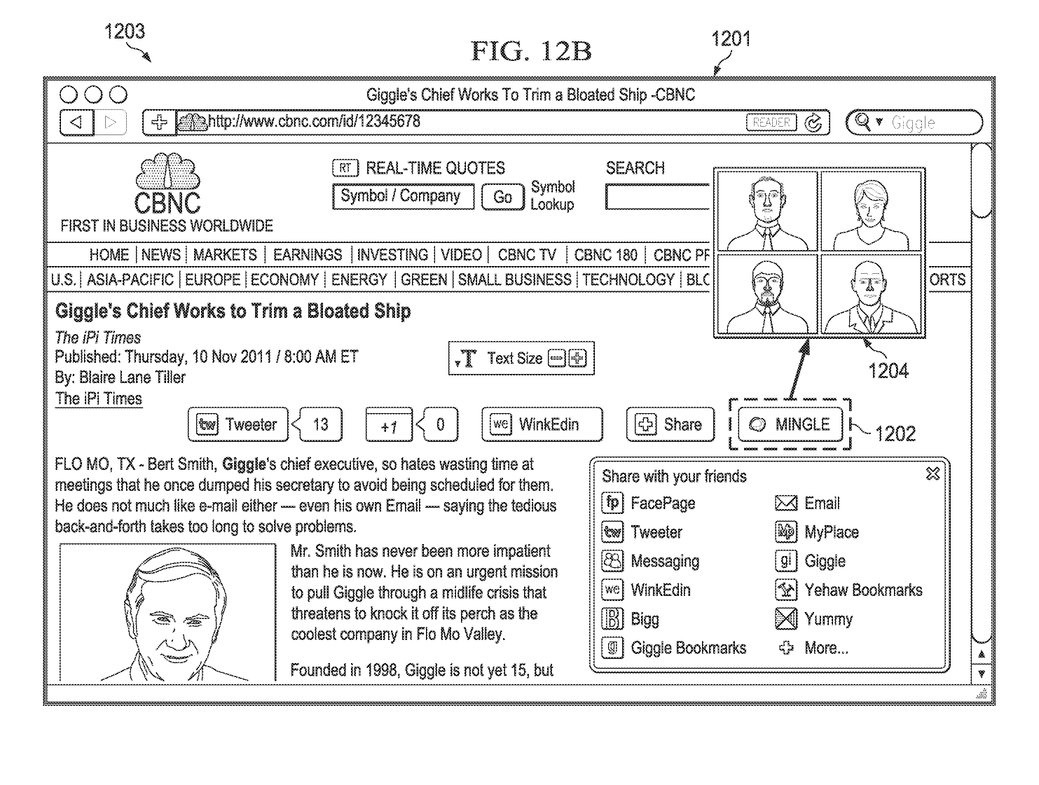

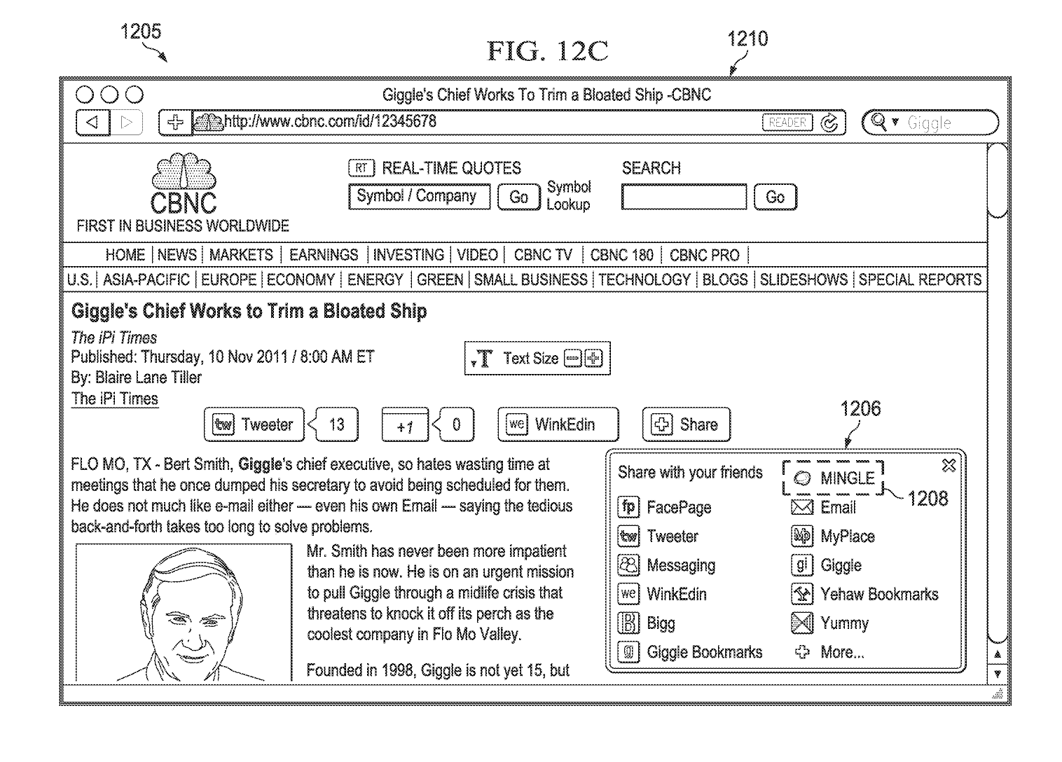

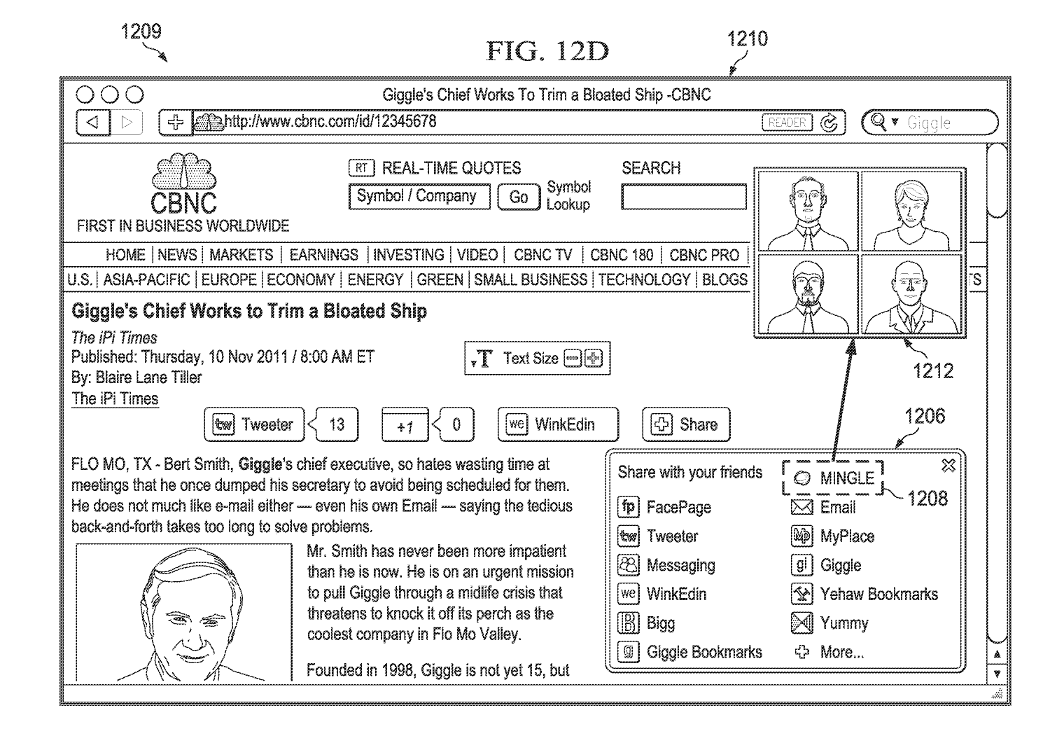

FIG. 12A is an example screenshot 1200 of a news article webpage 1201 acting as a web anchor for a community of interest. FIG. 12A shows a Mingle icon 1202 that a user can select to execute a CoIN interface. FIG. 12B is an example screenshot 1203 of a community of interest network for the news article webpage 1201 of FIG. 12A. By selecting the Mingle button 1202, a CoIN interface 1204 is displayed and through which CoIN services can be accessed.

FIG. 12C is an example screenshot 1205 of a share functionality associated with the community of interest for a news article webpage 1210. On webpage 1210, the Mingle button 1208 is located as part of the webpage's share functionality. Mingle, therefore, becomes a way to share the article using CoIN communication services 1206. FIG. 12D is an example screenshot 1209 of the share functionality associated with the community of interest for the news article webpage of FIG. 12C. Selecting the Mingle icon 1208 on the webpage 1210 causes the CoIN interface 1212 to be displayed, which allows the user to share the article using the CoIN communication services 1206.

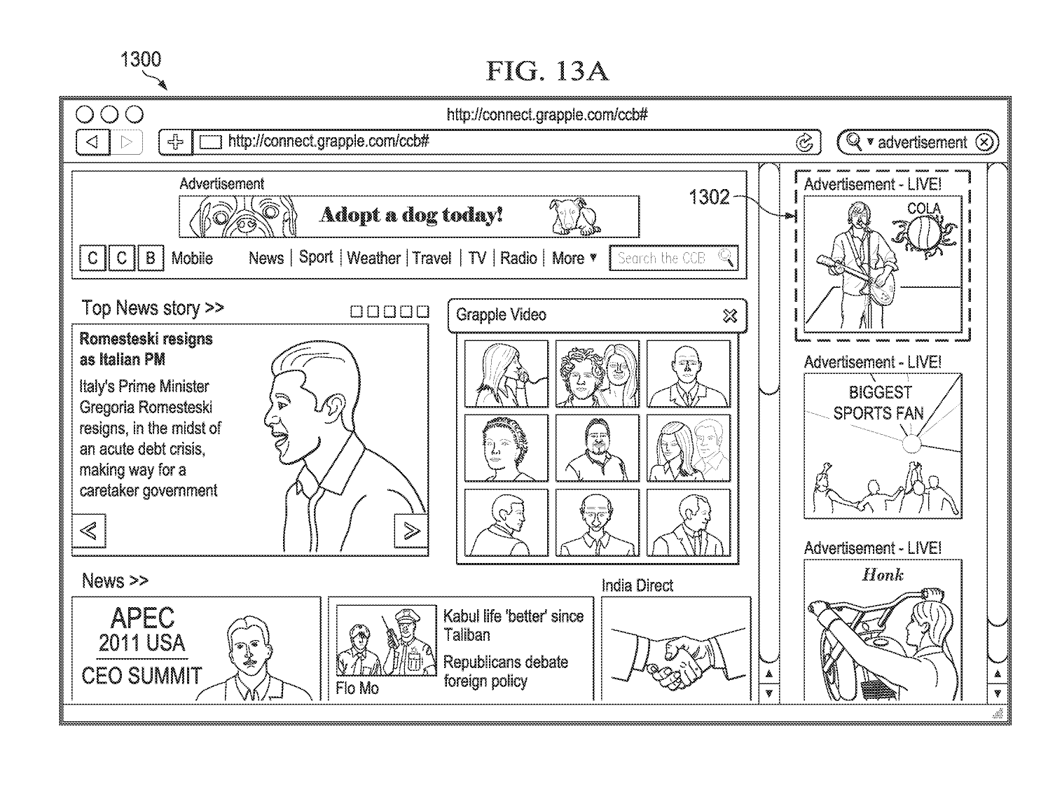

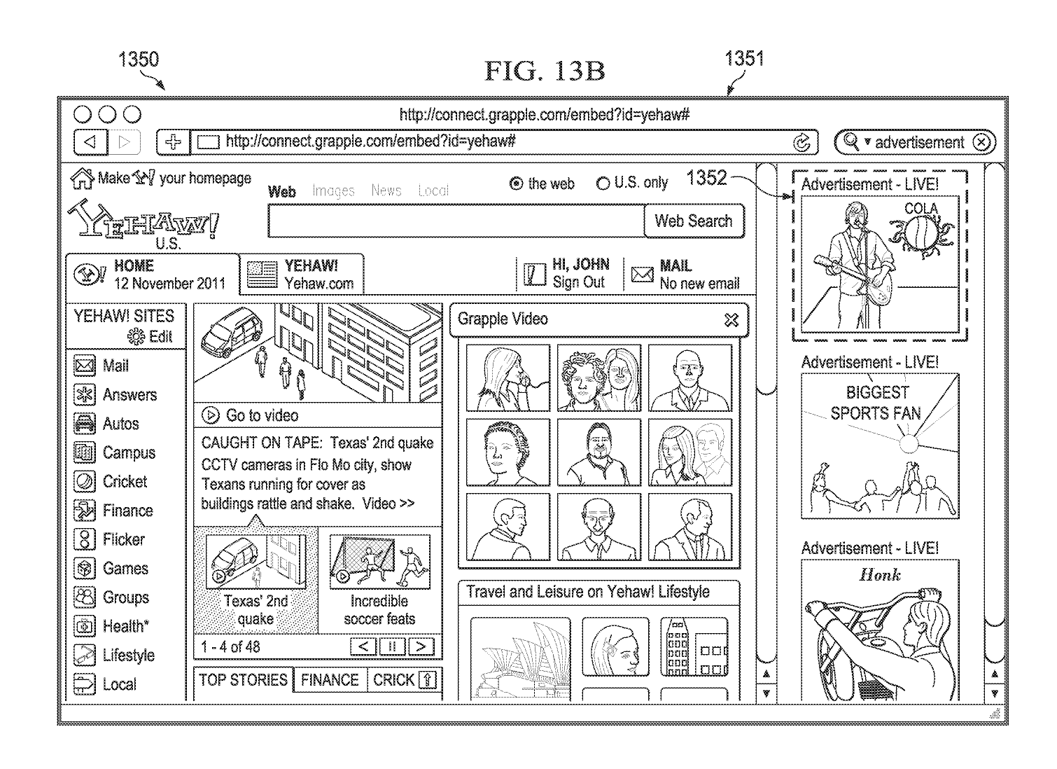

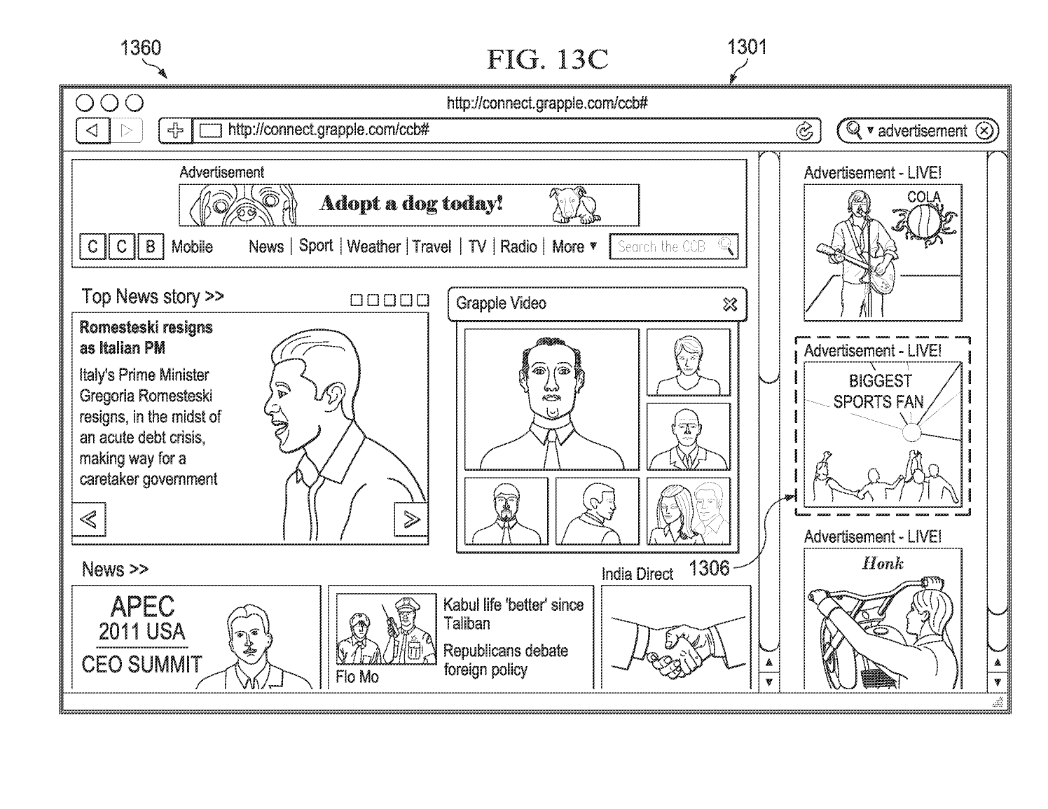

FIG. 13A is an example screenshot 1300 of a first webpage highlighting an embedded advertisement 1302 that acts as a community of interest network anchor. An advertisement (or ad) can have an associated CoIN. Selecting an ad can allow a user to join a CoIN associated with the ad. The advantage of using an ad CoIN is that the same ad can be shown on different webpages to different viewers in different locations. FIG. 13B is an example screenshot 1350 of a second webpage 1351 with the embedded advertisement 1352 shown in FIG. 13A that acts as an anchor for the community of interest network associated with the advertisement. Ad 1352 is similar to ad 1302 shown in FIG. 13A. Clicking on the ad 1352 allows a user to join the same CoIN associated with ad 1302 of FIG. 13A. FIG. 13C is an example screenshot 1360 of the webpage 1301 of FIG. 13A with another embedded advertisement 1306 highlighted that acts as a community of interest network anchor. Selecting ad 1306 would allow a user to join a different CoIN associated with ad 1306.

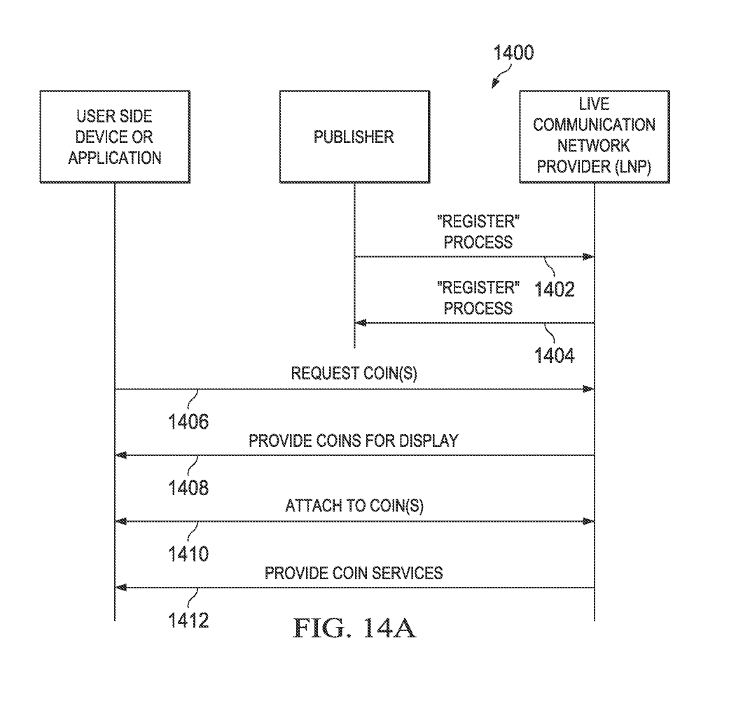

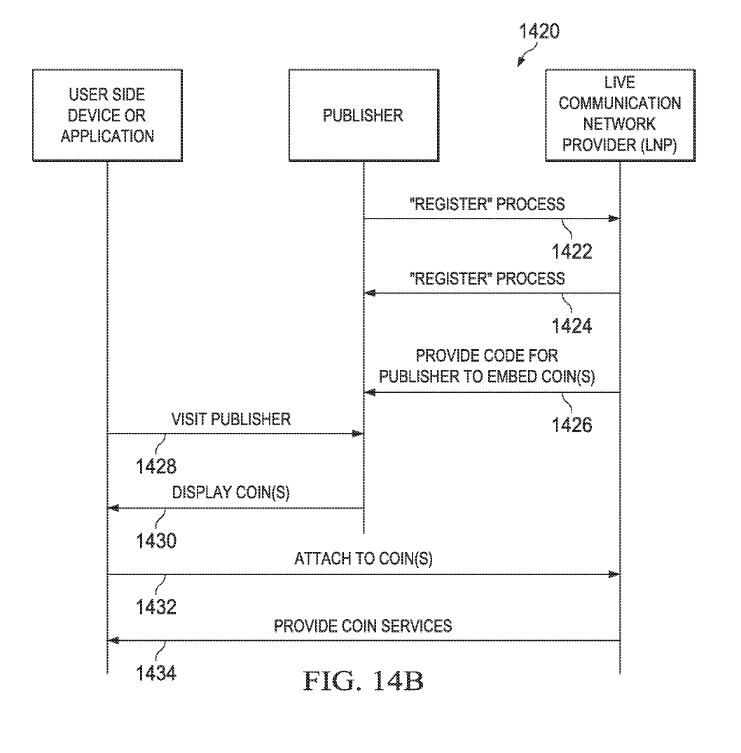

FIG. 14A is a swim-lane diagram 1400 showing an example process flow for registering for communication services and community of interest parameters and providing community of interest services from a communication services provider. The publisher registers with the LNP (1402). The registration process was described above in connection to FIGS. 2-3. The LNP participates in the registration process 1404 as described above. The user can request access to a CoIN (1406). The LNP can provide CoINs for display to the user (1408). The user can select a CoIN or CoINs to join and attach to the CoIN (1410). Attachment to the CoIN follows a process described above in connection with FIGS. 7A-B. The LNP can then provide CoIN services (1412).

FIG. 14B is a swim-lane diagram 1420 showing an example process flow for registering for communication services and community of interest parameters and providing community of interest services through a publisher. A publisher can register with an LNP (1422), which also participates in the registration process (1424).

Registration was discussed above in connection with FIGS. 2-3. The LNP can provide code for the publisher to embed in webpages (1426). The code can be embedded into various portions of the webpage. An icon can appear on the webpage allowing a user to access the CoIN. A user can visit a webpage of the publisher (1428). The CoINs can be displayed to the user (1430). CoIN functionality can be revealed to the user when the user hovers over certain areas on the webpage overlayed with the CoIN identifiers. For example, hovering over the share icon can reveal CoIN functionality. Or, icons can be placed on the website indicating a CoIN. The user can then join and attach to the CoIN (1432). Attachment to a CoIN is discussed above in connection with FIGS. 7A-B. The CoIN services can be provided (1434).

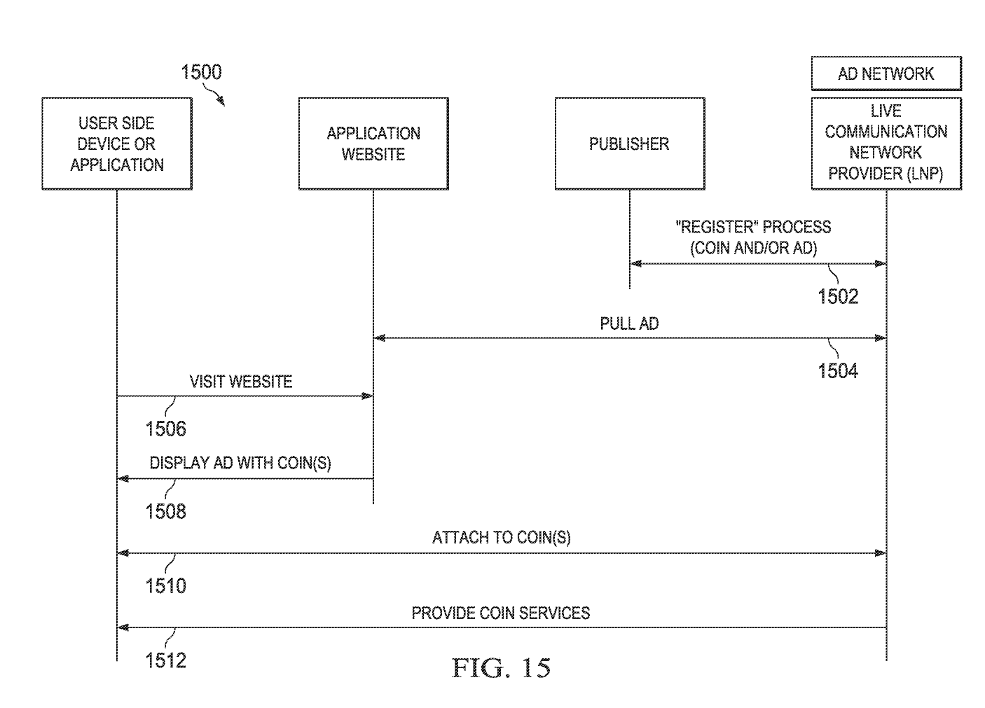

FIG. 15 is a swim-lane diagram 1500 showing an example process flow for registering and providing CoIN services using advertisements. A publisher can register for services in a similar manner as described above in connection with FIGS. 2-3. In this case, however, the registration process can also include an ad network. The registration process includes registering with the ad network, which provides ads for the webpage. The CoIN parameters can be established in connection with both the publisher profile and those of the ad network. The CoINs are embedded into the advertisements so that when a user hovers over an ad, CoIN functionality is revealed, and can be selected. Or, when a user clicks on the ad, the CoIN functionality can be accessed. The ad network registers the CoIN and/or the ad. (1502) The ad can be pulled from the ad network (1504). The ad is displayed to the user when the user visits the webpage (1506). The ad may be pulled when the user visits the webpage, and the type of ad may be selected from the ad network based on certain user profile information, such as cookies, location information, etc. The particular ad selected may have CoIN functionality that corresponds to user network activity or may be more generic. That is, the ad selected may include CoIN functionality for users in a particular geographic location (such as local vendors); or the ad may have CoIN functionality that is generic (such as that associated with a national advertising campaign). The ad may be displayed to the user (1508). The user can attach to the CoIN (1510). This can be done in a similar fashion as that described above for FIGS. 7A-B. The CoIN services can then be provided (1512). The CoINs provided in this scenario are associated with the ad network, but other CoINS associated with the publisher can also be registered in the manner described in this disclosure.

A number of embodiments of the invention have been described. Nevertheless, it will be understood that various modifications may be made without departing from the spirit and scope of the invention. Accordingly, other embodiments are within the scope of the following claims.

What is claimed is:

1. A system for providing a community of interest network (CoIN), the system comprising:
a publisher configured to provide content to a user across a network, the publisher configured to identify a CoIN parameter based on user network activity; and
a communications services provider configured to provide communications services to the user across the network based on the identified community of interest network.

2. The system of claim 1, wherein the user network activity is the user visiting a web page offered by the content provider.

3. The system of claim 1, wherein the content provider is configured to register a community of interest with the communications services provider, the community of interest used by the communications services provider to identify the services associated with a community of interest network.

4. The system of claim 3, wherein the communication service provider provides communications services to the user upon identification of a community of interest network based on a parameter provided by the content provider.

5. The system of claim 1, wherein the publisher is configured to identify a COIN parameter based on user network activity with no interruption to the publishing of content.

6. An apparatus comprising:
at least one hardware processor to execute instructions comprising:
receiving registration information;
parsing the registration information to identify one or more community of interest parameters; and
storing the registration information and the community of interest parameters.

7. The apparatus of claim 6, wherein the community of interest parameters includes one or more of network activity, search keywords, tagwords, algorithms, webpage portion, website or webpage domains, uniform resource locators, uniform resource identifiers, cookie information, Internet browsing history information, device type, CoIN lifetime or operational times, communication services for a particular CoIN or authorized enhancements thereto.

8. The apparatus of claim 6, wherein the registration information includes one or more of default settings; billing information; user information; location information; content type; marketing information; bandwidth limitations; contact information; coding; or other resources for automated communication systems.

9. The apparatus of claim 6, wherein the instructions further comprise receiving application programming interface (API) keys associated with a publisher.

10. An apparatus comprising:
at least one hardware processor operable to execute instructions comprising:
identifying one or more communications services associated with a community of interest network (CoIN).

11. The apparatus of claim 10, wherein the instructions further comprise:
identifying a request for video conferencing services;
identifying that video conference services are within a set authorized communications services;
providing a notification to users of the CoIN that video conferencing is available; and
providing an interface for video conferencing to at least a portion of the users of the CoIN.

12. An apparatus comprising:
at least one hardware processor operable to execute instructions comprising:
validating a request to establish a network service,
exchanging billing and service parameters; and
associating a dynamic community of interest with the network service.

13. The apparatus of claim 7, wherein the instructions further comprise providing the network service requested by members of CoIN.

14. An apparatus comprising:
at least one hardware processor operable to execute instructions comprising:
enables the extension of one or more network services of a first type associated with a community of interest network to network domains of a second type.

15. The apparatus of claim 14, wherein the network domain of the second type includes one or more of Play Station Network, xBox Live Network, Mobile Cellular Network, Public Telephony Network, Email network, SMS network, or Instant Messaging Network.

16. A computer implemented method for providing a community of interest network, the method comprising:
receiving an indication of network activity of a user;
identifying a community of interest network based on the indication for online content; and
instructing a processor to provide the user with communication services associated with the community of interest network.

17. The computer implemented method of claim 16, wherein instructing a processor to provide the user with communication services associated with the community of interest network includes instructing a communications service provider to provide the user with communication services across a network.

18. The computer implemented method of claim 16, further comprising providing a list of parameters to a communications service provider, the list of parameters identifying at least a community of interest associated with a community of interest network.

19. The computer implemented method of claim 16, further comprising identifying a communications service associated with the community of interest network.

20. The computer implemented method of claim 16, wherein receiving the indication of network activity comprises receiving an indication that the user is visiting a web page associated with an online content provider.

21. The computer implemented method of claim 16, wherein the user is making an online query.

22. The computer implemented method of claim 16, wherein the network activity comprises connecting to a Wi-Fi hotspot.

23. The computer implemented method of claim 16, wherein receiving the indication of network activity comprises receiving an indication across a network of the user's location.

24. The computer implemented method of claim 23, wherein the network activity consists of viewing a TV channel.

25. A computer implemented method for providing community of interest network services, the method comprising:
receiving an indication that a user is requesting access to a community of interest network;
identifying a community of interest network for the user based on a community of interest; and
providing communications services to the user across a network, the communication services configured to provide the user access to the community of interest network.

26. The computer implemented method of claim 25, further comprising receiving a registration from a content provider, the registration providing an indication of a community of interest.

27. A computer implemented method for establishing a community of interest network (CoIN), the method comprising:
receiving an indication from a user for access to content;
requesting a real-time network service across an Internet protocol (IP) network from a service provider;
receiving a real-time communications interface across the IP network from the service provider; and
providing the real-time communications interface to the user, the real-time communications interface associated with a community of interest associated with the content, the real-time communications interface facilitating live interactive communication between members of the community of interest network.

28. The computer implemented method of claim 27, further comprising adding the user to the community of interest network based on the indication from the user for access to the content.

29. The computer implemented method of claim 28, further comprising adding a second user to the community of interest network based on the indication from the second user for access to the second content.

30. The computer implemented method of claim 27, wherein the indication from the user is a keyword search, and the method further comprises:
identifying one or more community of interest networks based on the keyword search;
providing a listing of the one or more community of interest networks to the user;
receiving an indication from the user of one or more preferred community of interest networks; and
adding the user to the one or more communities of interest network.

31. The computer implemented method of claim 30, further comprising:
identifying one or more related community of interest networks based on the one or more preferred community of interest networks, the one or more related community of interest networks associated with subjects related to subjects associated with the one or more preferred community of interest networks; and
providing the related community of interest networks to the user.

32. The computer implemented method of claim 27, wherein the indication from the user is a keyword search, and the method further comprises:
identifying one or more communities of interest based on the keyword search;
adding the user to the one or more communities of interest;
identifying one or more subscribers to the identified one or more communities of interest; and
providing an indication to the one or more subscribers of the addition of the user to the community of interest.

33. The computer implemented method of claim 27, wherein the user provides the indication for content through a web browser.

34. The computer implemented method of claim 27, wherein the indication from the user for content automatically adds the user to the community of interest associated with the requested content.

35. The computer implemented method of claim 27, wherein the real-time communications interface facilitates live, interactive video between members of the community of interest network.

36. The computer implemented method of claim 27, wherein the live communications interface facilitates one or a combination of a text-based communications session, a voice-based communications session, a video-based communications session, or other online interactive communications session between members of the community of interest.

37. The computer implemented method of claim 27, further comprising activating a video session in the user's web browser, a video service system providing a live interactive two-way video between the user's web browser and the web browsers of other members of the community of interest network.

38. The computer implemented method of claim 27, wherein the members of the community of interest network include one or more of a publisher of a website and users of the website.

39. The computer implemented method of claim 27, wherein the community of interest is one of a plurality of parameters for establishing the community of interest network.

40. The computer implemented method of claim 39, wherein the one of the plurality of parameters is a second community of interest.

41. The computer implemented method of claim 27, wherein the community of interest network is established by one or more of a plurality of parameters, the parameters including one or a combination of network activity, search keywords, tagwords, algorithms, webpage portion, website or webpage domains, uniform resource locators, uniform resource identifiers, cookie information, device type, CoIN lifetime, or operational times.

42. The system of claim 1, wherein instructions further comprise associating the content with a community of interest (CoI), the CoI used to establish the CoIN.
